(19) United States
(12) Patent Application Publication
(10) Pub. No.: US 2019/0324797 A1
(43) Pub. Date: Oct. 24, 2019

(54) TASK PROCESSING METHOD, APPARATUS, AND SYSTEM

(71) Applicant: ALIBABA GROUP HOLDING LIMITED, George Town (KY)

(72) Inventor: Jiaguo MIAO, Hangzhou (CN)

(73) Assignee: ALIBABA GROUP HOLDING LIMITED

(21) Appl. No.: 16/388,520

(22) Filed: Apr. 18, 2019

(30) Foreign Application Priority Data
Apr. 18, 2018 (CN) 201810348626.X

(51) Int. Cl. G06F 9/48; G06F 9/52; G06F 9/50

(52) U.S. Cl. CPC G06F 9/4843; G06F 9/52; G06F 2209/508; G06F 2209/481; G06F 9/5027

(57) ABSTRACT

The present disclosure discloses task processing methods, apparatus, and systems. One exemplary task processing method comprises: acquiring a target task to be deployed to a target device; generating a confirmation signal according to the target task, the confirmation signal including task content of the target task; and sending the confirmation signal to the target device when a heartbeat request from the target device is received. The target device can execute the target task according to the task content. Consistent with the disclosed embodiments, the target device can be an edge device close to the data source and executing the target task can include running cloud computing logic and applications on the edge device.

### CROSS-REFERENCE TO RELATED APPLICATION

The present disclosure claims priority to and benefit of Chinese Patent Application No. 201810348626.X, filed on Apr. 18, 2018, which is incorporated herein by reference in its entirety.

### TECHNICAL FIELD

The present disclosure generally relates to the field of computer technologies, and in particular, to methods, apparatus, and systems for task processing in Internet of Things (IoT).

### BACKGROUND

With the development of IoT technologies, there is an increasing number of IoT devices accessing the cloud, thereby presenting increasingly complicated application scenarios. In the existing technologies, all data of the devices is reported to the cloud where computing is performed. That means a large amount of cloud computing resources are occupied, leading to high network bandwidth costs. However, logical processing of most tasks does not require the use of the distributed computing capability of cloud clusters. Further, most of the cloud data does not warrant direct computing.

In view of the above, edge computing can be particularly important relative to cloud computing. Edge computing can reduce the response time to a request from a device. It can also reduce the network costs of communication between the device and the cloud, and reduce service load of the cloud as well. In light of the current development of edge computing, there is a need for techniques for deploying cloud computing logic and applications on an edge device close to the data source side.

### SUMMARY

Embodiments of the present disclosure provide task processing methods, apparatus, and systems. One objective of the embodiments provided herein is to address the technical problems of how to deploy and run cloud computing logic and applications on an edge device close to the data source side.

According to some embodiments of the present disclosure, task processing methods performed by a scheduling device are provided. One exemplary method comprises: acquiring a target task to be deployed to a target device; generating a confirmation signal according to the target task, the confirmation signal indicating task content of the target task; and in response to a heartbeat request being received from the target device, sending the confirmation signal to the target device. The target device can execute the target task according to the task content.

According to some embodiments of the present disclosure, task processing methods performed by a network device are further provided. One exemplary method comprises: sending a heartbeat request to a scheduling device; receiving, from the scheduling device, a confirmation signal corresponding to the heartbeat request, the confirmation signal indicating task content of a target task; and executing the target task according to the task content.

According to some embodiments of the present disclosure, task processing methods performed by a scheduling device are further provided. One exemplary method comprises: starting a scan thread; calling a scan logic function in the scan thread to scan a plurality of objects; and determining whether the plurality of objects include one or more abnormal objects. In response to the number of determined abnormal objects being greater than or equal to a preset threshold, an exception handling function can be called to process the plurality of objects.

According to some embodiments of the present disclosure, task scheduling apparatus are further provided. One exemplary task scheduling apparatus comprises: a memory storing a set of instructions; and a processor configured to execute the set of instructions to cause the task scheduling apparatus to: acquire a target task to be deployed to a target device; generate a confirmation signal according to the target task, the confirmation signal indicating task content of the target task; and in response to a heartbeat request being received from the target device, send the confirmation signal to the target device. The target device can execute the target task according to the task content.

According to some embodiments of the present disclosure, network apparatus for task processing are further provided. One exemplary network apparatus comprises: a memory storing a set of instructions; and a processor configured to execute the set of instructions to cause the network apparatus to: send a heartbeat request to a scheduling device; receive, from the scheduling device, a confirmation signal corresponding to the heartbeat request, the confirmation signal indicating task content of a target task; and execute the target task according to the task content.

According to some embodiments of the present disclosure, task scheduling apparatus are further provided. One exemplary apparatus comprises: a memory storing a set of instructions; and a processor configured to execute the set of instructions to cause the task scheduling apparatus to: start a scan thread; call a scan logic function in the scan thread to scan a plurality of objects; and determine whether the plurality of objects include one or more abnormal objects. In response to the number of determined abnormal objects being greater than or equal to a preset threshold, an exception handling function can be called to process the plurality of objects.

According to some embodiments of the present disclosure, task processing systems are further provided. The task processing system can include one of the task scheduling apparatus embodiments of the present disclosure.

According to some embodiments of the present disclosure, processors configured to run a program are further provided. When the program is executed, the program can cause the processor to perform the following task processing functions: acquiring a target task to be deployed to a target device; generating a confirmation signal according to the target task, the confirmation signal indicating task content of the target task; and in response to a heartbeat request being received from the target device, sending the confirmation signal to the target device.

According to some embodiments of the present disclosure, storage media including a program stored therein are further provided. When the program is executed, the program can control a device in which the storage medium resides to perform the following task processing procedures: acquiring a target task to be deployed to a target device; generating a confirmation signal according to the target task, the confirmation signal indicating task content of the target task; and in response to a heartbeat request being received from the target device, sending the confirmation signal to the target device.

According to some embodiments of the present disclosure, a target task can be acquired. The target task can be a task that needs to be deployed on a target device. A corresponding confirmation signal can be generated according to the target task. The confirmation signal can include task content of the target task. The confirmation signal can be sent to the target device when a heartbeat request from the target device is received. The target device can execute the target task according to the task content. In this way, the task processing rate of edge computing and the stability of the edge operating system can be increased. Further, the technical effect of reducing the response time to a request from a device can be achieved by increasing the task processing rate of edge computing. Therefore, the techniques provided in the present disclosure can address the technical problem of deploying and running cloud computing logic and applications on an edge device close to the data source side.

### BRIEF DESCRIPTION OF THE DRAWINGS

The accompanying drawings described here are used to provide further understanding of the present disclosure, and constitute a part of the present disclosure. Exemplary embodiments of the present disclosure and descriptions of the exemplary embodiments are used to explain solutions provided in the present disclosure. The embodiments described herein do not constitute inappropriate limitations to the present disclosure. In the accompanying drawings:

FIG. 1 is a structural hardware block diagram of an exemplary computer terminal configured to implement a task processing method, according to some embodiments of the present disclosure.

FIG. 2 is a flowchart of an exemplary task processing method, according to some embodiments of the present disclosure.

FIG. 3A is a schematic diagram illustrating state transition of an exemplary state machine, according to some embodiments of the present disclosure.

FIG. 3B is a schematic diagram illustrating state transition of an exemplary state machine, according to some embodiments of the present disclosure.

FIG. 4 is a flowchart of an exemplary task processing method, according to some embodiments of the present disclosure.

FIG. 5 is a flowchart of an exemplary task processing method, according to some embodiments of the present disclosure.

FIG. 6 is a schematic interaction diagram of an exemplary task processing method, according to some embodiments of the present disclosure.

FIG. 7 is a flowchart of an exemplary task processing method, according to some embodiments of the present disclosure.

FIG. 8 is a flowchart of an exemplary task processing method, according to some embodiments of the present disclosure.

FIG. 9 is a flowchart of an exemplary task processing method, according to some embodiments of the present disclosure.

FIG. 10 is a flowchart of an exemplary ask processing method, according to some embodiments of the present disclosure.

FIG. 11 is a schematic structural diagram of an exemplary task processing apparatus, according to some embodiments of the present disclosure.

FIG. 12 is a schematic structural diagram of an exemplary task processing apparatus, according to some embodiments of the present disclosure.

FIG. 13 is a schematic structural diagram of an exemplary task processing apparatus, according to some embodiments of the present disclosure.

### DETAILED DESCRIPTION

In order to facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure.

It is appreciated that terms such as “first” and “second” in the specification, the claims, and the accompanying drawings of the present disclosure, are used to distinguish similar objects. These and similar terms are not intended to describe a specific sequence or order. It should be appreciated that content described in this manner can be interchanged in suitable situations. For example, embodiments of the present disclosure described here can be implemented in sequences other than those shown or described here. Moreover, terms “include,” “comprise” and any variation thereof are intended to cover non-exclusive inclusion. For example, a process, method, system, product or device including a series of steps or units is not limited to those steps or units clearly listed, but may include other steps or units that are not explicitly listed or are inherent to the process, method, product or device.

According to some embodiments of the present disclosure, task processing methods are provided. It is appreciated that the procedures shown in the flowcharts of the accompanying drawings may be executed in a computer system through a set of computer executable instructions. Moreover, although a logic order may be shown in the flowcharts, in some embodiments, the procedures shown or described can be executed in an order different from that described here.

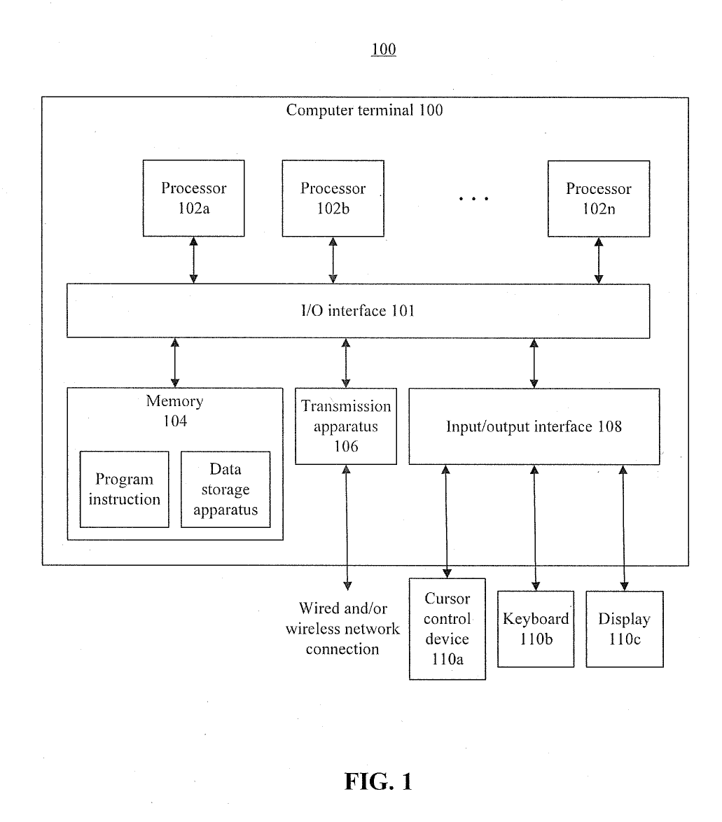

Method embodiments provided in the present disclosure may be executed in a mobile terminal, a computer terminal, or a similar computing device. FIG. 1 is a structural hardware block diagram of an exemplary computer terminal configured to implement task processing methods according to some embodiments of the present disclosure. In some embodiments, the computer terminal can be in the form of a mobile device. As shown in FIG. 1, a computer terminal 100 (or the mobile device 100) may include one or more processors 102, denoted by 102a, 102b, . . . , 102n in the figure. As noted above, computer terminal 100 may also be a mobile device. Processor 102 may include, but is not limited to, a processing apparatus such as a microprocessor (e.g., a microcontroller unit (MCU)) or a programmable logic device (e.g., a field programmable gate array (FPGA)).

Computer terminal 100 can also include a memory 104 configured to store data, and a transmission apparatus 106 configured to provide a communication function. In addition, computer terminal 100 may further include: an input/output interface 108 (I/O interface), a universal serial bus (USB) port, a network interface, a power supply and/or a camera. The USB port may also be included as one of the ports in the I/O interface. As shown in FIG. 1, computer terminal may further include a cursor control device 110a, a keyboard 110b, and a display 110c. Those of ordinary skill in the art can understand that the structure shown in FIG. 1 is merely schematic, provided as an example. The structure shown in FIG. 1 is not intended to limit the structure of the above electronic apparatus. For example, in some embodiments, computer terminal 100 may include more or fewer components than those shown in FIG. 1, or have a configuration different from that shown in FIG. 1.

It should be appreciated that the one or more processors 102 and/or other data processing circuits may also be referred to as a data processing circuit. The data processing circuit may be embodied in whole or in part as software, hardware, firmware or any other combination. Moreover, the data processing circuit can be a single, separate processing module, or incorporated in whole or in part into any of the other components in computer terminal 100. In some embodiments of the present disclosure, the data processing circuit can be controlled as a processor, for example, through selection of a variable resistance terminal path connected to the interface.

Memory 104 may be configured to store a software program or modules of application software, for example, a program instruction/data storage apparatus corresponding to the task processing methods provided in the present disclosure. Processor 102 can execute the software program or modules stored in memory 104, to execute various functions and applications, and perform data processing. For example, processor 102 can execute the software program or modules to perform a task processing method. Memory 104 may include a high-speed random-access memory, or a non-volatile memory, such as one or more magnetic storage apparatuses, a flash memory, or other non-volatile solid-state memory. In some embodiments, memory 104 may further include memories remotely disposed with respect to processor 102. The remote memories may be connected to computer terminal 100 through a network. Examples of the network can include, but are not limited to, the Internet, an Intranet, a local area network, a mobile communication network, and their combinations.

Transmission apparatus 106 can be configured to receive or send data via a network. For example, the network may include a wireless network provided by a communication provider of computer terminal 100. In some embodiments, transmission apparatus 106 can include a Network Interface Controller (NIC), which can be connected to another network device via a base station to communicate with the Internet. In some embodiments, transmission apparatus 106 may be a Radio Frequency (RF) module, which can be configured to communicate with the Internet in a wireless manner.

Display 110c can be, for example, a touchscreen liquid crystal display (LCD) that enables a user to interact with a user interface of computer terminal 100.

It is appreciated that the structural hardware block diagram shown in FIG. 1 is provided only as an exemplary block diagram of computer terminal 100. In some embodiments, computer terminal 100 may be part of or connected to an exemplary server. Computer terminal 100 may be connected to one or more servers such as a cloud server, a security server, a resource server, and a game server. The connection may be in the form of data network connection or electronic connection. In some embodiments, computer terminal 100 may be an mobile computing device or the like. The data network connection may be a local area network connection, a wide area network connection, an Internet connection, or other type of data network connection. Computer terminal 100 may, through network service, connect to one server (for example, a security server) or a group of servers. The network service can be a network-based user service such as a social network, cloud resources, email, online payment, or other online applications.

In some embodiments provided by the present disclosure, logic units can be deployed on an edge gateway, for example, logic units relating to data filtering, format conversion, basic operations, scripts, and rules. That way, the response time to a request from a device can be reduced. Further, the network costs of communication between the device and the cloud as well as the service load of the cloud can be reduced.

A distributed resource scheduling device in the cloud can be used for centralized management of cloud computing resources, providing an application logic hosting capability for the user. One main function of the scheduling device relates to tenant resource isolation and resource allocation. However, since the edge-side running nodes are generally provided by edge computing users themselves, tenant isolation does not present a serious issue.

Edge computing can refer to the technology that can schedule and deploy cloud logic on an edge. On the side close to the object or data source, edge computer technology uses an open platform that integrates network, computing, storage, and application core capabilities to provide near-end services. An application of edge computing can be initiated on the edge side, to provide a faster network service response. That way, edge computing can fulfill the basic requirements associated with real-time services, application intelligence, security and privacy protection.

Due to cloud-based integrated development, the edge-side runtime environment can be much harsher than the cloud-side runtime environment. In view of the above, there is a need to ensure stability and data consistency of the edge-side runtime environment. When a task in a cloud is deployed to a runtime environment on an edge, a self-detection mechanism may be needed to be configured on the edge to monitor whether an exception occurs in the runtime environment on the edge. That way, corresponding exception handling can be performed according to the particular exception event. In addition, the upper-level developers may need to know the life cycle of the task deployed. Therefore, it may also be necessary to configure an effective task status management mechanism on the edge, to monitor the life cycle and task status of the task deployed.

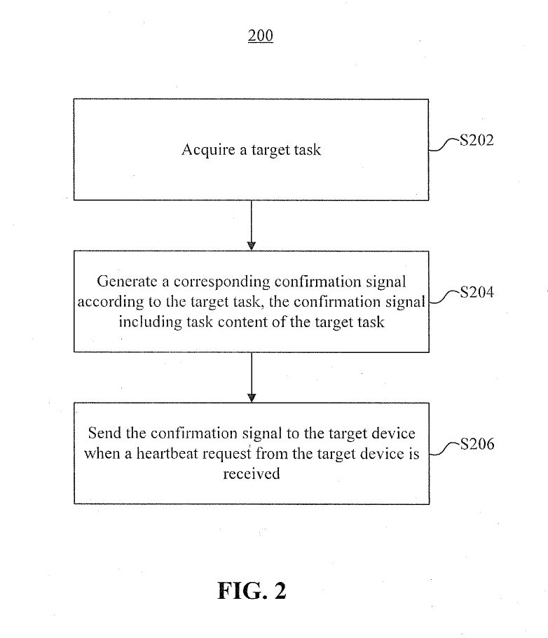

In view of the above described runtime environment, the present disclosure provides task processing methods, such as the one described below and shown in FIG. 2. It is appreciated that the task processing method embodiments provided by the present disclosure may be executed in a scenario other than the edge computing. According to some embodiments, the edge-side runtime environment, the task deployment status, the operating signal status and the like can be monitored and managed. That way, self-detection of and compensation for an exception on the edge gateway device can be performed. One advantage of the embodiments provided in the present disclosure is that the stability and data consistency of the edge-side runtime environment can be improved.

It is appreciated that the embodiments of the task processing methods provided by the present disclosure can be applied to emerging IoT fields such as smart industry, smart city, unmanned supermarket, and smart hotel. The solutions provided herein can improve the task processing rate of edge computing, and reduce the response time to a request from a device.

FIG. 2 is a flowchart of an exemplary task processing method 200, according to some embodiments of the present disclosure. As shown in FIG. 2, task processing method 200 may include the following procedures: step S202 to step S206.

In step S202, a target task is acquired. The target task can be a task that needs to be deployed on a target device.

It is appreciated that method embodiments described here may be executed by a scheduling device, for example, a cloud scheduling device. The scheduling device can acquire a target task that needs to be deployed on an edge, and generates a corresponding confirmation signal according to the target task. When receiving a heartbeat request from a target device, the scheduling device can send the confirmation signal to the target device. The target device can execute the target task according to the task content.

In some embodiments, the target task can be a task that may be deployed and executed on the target device. The target task may be, but is not limited to, a task relating to data filtering, format conversion, basic operations, scripts, rules, configuration, and applications. The target device may be an edge gateway device, a base station, or a cloud server, such as an edge cloud server. An edge-side execution node for providing a runtime environment for various execution engines may be deployed on the target device.

An edge-side execution node can refer to a node that can provide a runtime environment for various execution engines and can be deployed on an edge gateway device or an open-source application container, such as a Docker container. An engine driver can support the integration of a standard-compliant execution engine as a plug-in in the runtime environment. Execution engines implemented using various languages can be managed by means of inter-process communication via a data bus.

In some embodiments, the target task may be acquired in, but not limited to, the following manner.

In step S2021 (not shown in FIG. 2), receiving a first task sent by a console. The first task can include, for example, a scheduling policy, a deployment address, and task content. The scheduling device may receive the first task submitted by the console. When the console submits the first task to the scheduling device for deployment, information such as a scheduling policy, a deployment address, task content, and an execution engine in the first task can be specified.

In step S2023 (not shown in FIG. 2), parsing the deployment address, and detect a status of the target device indicated by the deployment address. The status of the target device may be, but is not limited to, a status of an execution node in the target device.

In some embodiments, the scheduling device can parse the deployment address, and detect the status of the execution node of the target device. The scheduling device can further record a task snapshot of the target device, and check a format of the task content. With the above information, the scheduling device can determine whether the status of the target device is normal.

In step S2025 (not shown in FIG. 2), generating the target task according to the task content and the scheduling policy if the target device is in a normal state. In some embodiments, the scheduling policy may be, but is not limited to, any one of the following scheduling policies: single-point scheduling, specified scheduling, full scheduling, distributed scheduling, and the like. In some embodiments, if it is determined that the target device is in the normal state, the target task can be generated according to the task content and the scheduling policy.

Referring back to FIG. 2, in step S204, a corresponding confirmation signal is generated according to the target task. The confirmation signal can include task content of the target task.

The confirmation signal can further include at least one of the following: a task snapshot, a return code, and a consumption status.

In some embodiments, the scheduling device may acquire the device information of the target device. The corresponding confirmation signal can be generated according to the acquired target task and device information.

In some embodiments, the confirmation signal can include a response content field, and in step S204, the generating a corresponding confirmation signal according to the target task may be implemented by performing the following procedures: adding the task content to the response content field of the confirmation signal to obtain the confirmation signal.

In some embodiments, the response content field may be a response content field Ack Content, as shown in Table 1 below. The confirmation signal may be obtained by adding the task content of the target task to the response content field Ack Content.

In some embodiments, if the response content field Ack Content=10201, it can indicate that the scheduling device submits a new task to the target device, and the response content field carries information about the new task. If the response content field Ack Content=10204, it can indicate deleting a designated task on the target device, and the response content field Ack Content can be a to-be-deleted task identifier.

It is appreciated that a field value of the response content field Ack Content may be, but is not limited to, the foregoing examples. Different fields may be selected according to different actual implementations. In some embodiments, a data structure of the confirmation signal may be, but is not limited to, the structure as shown in Table 1 below:

TABLE 1

| Attribute name | Attribute type | Description information |
|---|---|---|
| Runtime environment | long | Return code of scheduling |
| identifier - runner ID | | device |
| Executor | String | Response information |
| Task identifier - Job ID | long | Unique task identifier |
| Response code - Ack Code | int | Return code |
| Response content field - | String | Response content informa- |
| Ack Content | | tion |

In some embodiments, when the target device is started, a runtime manager can load various execution engines. Each execution engine can have a corresponding name space. Execution engines implemented using different languages may be managed by means of inter-process communication. For example, the runtime manager can send a broadcast to a data bus. After receiving the broadcast, each execution engine process can initiate an engine registration request to an address of the runtime manager.

It is appreciated that before the scheduling device acquires the target task, the target device may acquire local device information. For example, the local device information can include information regarding central processing unit (CPU), memory size, disk size, network link, software development kit (SDK) version number, execution engine information, address information, synchronization time interval, configuration information, and the like. The target device can send the device information to the scheduling device, to implement registration at the scheduling device side.

In addition, the scheduling device can store the device information to achieve persistence of the device information. The scheduling device may also generate a unique runtime environment identifier corresponding to the target device. The runtime environment identifier corresponding to the target device may be provided to the target device by returning ACK information.

In step S206, the confirmation signal is sent to the target device when a heartbeat request from the target device is received. The target device can execute the target task according to the task content.

In some embodiments, the heartbeat request can include information on at least one of the following: CPU usage, memory usage, disk usage, and execution status of one or more tasks.

In some embodiments, the heartbeat request may be a heartbeat packet sent by the target device to the scheduling device at fixed time intervals, for example, 30-40 s, or other intervals. The heartbeat request may be used for indicating that current connection between the target device and the scheduling device is normal. Packet content of the heartbeat request is not limited in the present disclosure. In some embodiments, the packet content can be, but is not limited to, a null packet including only a header, as long as the packet can be used for keepalive and disconnection of a long connection.

In some embodiments, if the target device successfully registers with the scheduling device, the target device may locally start a heartbeat daemon thread and send the heartbeat request to the scheduling device according to a fixed frequency of a preset heartbeat rate.

In some embodiments, in step S206, the sending the confirmation signal to the target device may be implemented by performing the following procedures:

adding the confirmation signal to a data field of a heartbeat response; and

sending the heartbeat response including the confirmation signal to the target device.

In some embodiments, upon receiving the heartbeat request sent by the target device, the scheduling device can detect whether a corresponding confirmation signal exists locally. If the corresponding confirmation signal exists, the scheduling device can add the confirmation signal to a heartbeat response of the current heartbeat request, and send the heartbeat response including the confirmation signal to the target device. In some embodiments, the scheduling device may add the task content to the response content field of the confirmation signal to obtain the confirmation signal. A data structure of the confirmation signal may be, but is not limited to, the exemplary structure as shown in Table 1 above. In addition, the confirmation signal may be, but is not limited to, added to data of the heartbeat response. A data structure of the heartbeat response can be the exemplary structure as shown in Table 2 below.

TABLE 2

| Attribute name | Attribute type | Description information |
|---|---|---|
| code | int | 10200, indicating that there is a |
| | | confirmation signal to be processed |
| | | in the heartbeat response |
| message | String | Response information |
| data | List<NovaACK> | Confirmation signal list |

In some embodiments, the scheduling device may detect that the corresponding confirmation signal does not exist locally. An acknowledgment character indicating that the heartbeat request has been received can be returned to the target device, to acknowledge the reception of the heartbeat request of the target device.

In some embodiments, in addition to the pull mode described above, a push mode can also be applied. In the pull mode described above, after the scheduling device generates the corresponding confirmation signal according to the target task, the scheduling device can send the confirmation signal corresponding to the heartbeat request to the target device after receiving the heartbeat request of the target device. In the push mode, the scheduling device may actively push the confirmation signal to the target device after generating the confirmation signal, where the confirmation signal includes the task content of the target task. The push mode may be more applicable to some low-performance devices. One characteristic of the push mode is that it can reduce power consumption of low-performance devices.

In some embodiments, the confirmation signal including the task content may also be sent to the target device by using a combined protocol manner that combines the push mode and the pull mode. That way, a developer can switch between the modes according to actual implementation scenarios. For example, the combined protocol manner may be carried out by, but is not limited to: pushing a message to the target device after the scheduling device generates the confirmation signal. The target device can be instructed to pull the confirmation signal carrying the target task from the scheduling device.

In some embodiments, after receiving the confirmation signal, the target device may parse the confirmation signal to obtain the task content of the target task included in the confirmation signal, complete the deployment of the target task, and execute the target task according to the task content.

According to the above described embodiments of the present disclosure, a target task is acquired, the target task being a task that needs to be deployed on a target device. A corresponding confirmation signal can be generated according to the target task, where the confirmation signal includes task content of the target task. The confirmation signal can be sent to the target device when a heartbeat request from the target device is received. The target device can execute the target task according to the task content. With the solutions provided in the present disclosure, task processing rate of edge computing and the stability of the edge operating system can be improved. The technical effect of reducing the response time to a request from a device can be achieved by increasing the task processing rate of edge computing. The solutions provided herein can address the technical problem of how to deploy and run cloud computing logic and applications on an edge device close to the data source side.

The solutions provided by the present disclosure is described below by using an exemplary implementation scenario. In some embodiments, the scheduling device may include, but is not limited to, units/modules such as a parser, a deployer, a state machine, and a scanner. The parser can be connected to an upper-level application system. The parser can receive logical tasks of the upper-level application system for batch deployment, and accepts a multi-dimensional status query of the upper-level application system.

In some embodiments, the upper-level application system, as a console, may deliver a first task to the parser in the scheduling device. The first task can include: a scheduling policy, a deployment address, and task content. The parser can parse the deployment address to detect a status of the target device indicated by the deployment address. The parser can then generate the target task according to the task content and the scheduling policy if the target device is in a normal state.

In some embodiments, the deployer can be connected to the parser. After receiving the target task, the deployer may mark dual states for the target task to generate a dual-state record corresponding to the target state. The dual-state record can include an expected state and an actual state. The deployer can, for example, manage the target task, store the target task, create an ACK signal corresponding to the target task, and authorize connection of the target task.

In some embodiments, the state machine can be connected to the deployer. The state machine can receive a task synchronization request sent by the target device, and update the actual state in the dual-state record according to an execution status of the target task indicated in the task synchronization request.

In some embodiments, the state machine deployed in the scheduling device may record and identify the dual-state of the target task. The state machine can be used for managing state transition in the life cycle of the target task. The expected state and the actual state can include at least one of the following: non-running state, running state, running ended state, running failed state, and running suspended state.

It is appreciated that after receiving the task synchronization request of the target device, the scheduling device may update the actual state of the target task in the local dual-state record, according to the execution status of the target task indicated in the task synchronization request. The scheduling device can further determine that the target device has received the corresponding confirmation signal, and delete the local confirmation signal.

In some embodiments, a scanner can include a program that automatically detects security vulnerabilities of a local or remote host and can quickly and accurately detect vulnerabilities in a scan target. The scan result can be provided to the user. For example, the scanner can send a packet to a target computer, and determine information based on the information fed back by the target computer. The information determined can include information regarding an operating system type, development port, and a service provided by the target computer.

In some embodiments of the present disclosure, various units/modules can be deployed in the scheduling device, such as the parser, the deployer, the state machine, and the scanner in the scheduling device. The task processing rate of edge computing and the stability of the edge operating system can be improved. The technical effect of reducing the response time to a request from a device can be achieved by the improved task processing rate of edge computing. Further, it may be detected whether the target device and the target task are abnormal, so that corresponding exception handling process can be performed according to the particular abnormal situations. That way, the life cycle and the task status of the deployed target task can be effectively monitored.

In some embodiments, to perform detection of the execution status of the target task, after step S202 of acquiring a target task, the method can further include the following procedures:

In step S203 (not shown in FIG. 2), a dual-state record can be generated corresponding to the target task.

After acquiring the target task, the scheduling device can generate a dual-state record corresponding to the target task. The dual-state record can include an expected state and an actual state. The expected state can be used for indicating a state of predicted execution of the target task. The actual state can be used for indicating a state of actual execution of the target task. In some embodiments, the deployment of the target task in a running container may be implemented by using the deployer in the scheduling device. The deployer may first mark dual states for the target task, to generate the dual-state record corresponding to the target state.

After step S206 of sending the confirmation signal to the target device, the method can further include the following procedures.

In step S208 (not shown in FIG. 2), receiving a task synchronization request sent by the target device.

In step S210 (not shown in FIG. 2), updating the actual state in the dual-state record according to an execution status of the target task indicated in the task synchronization request.

Based on the procedures provided by step S208 to step S210, upon receiving the confirmation signal, the target device may parse the task content of the target task carried in the confirmation signal, execute the target task, and send an execution status of the target task to the scheduling device through a task synchronization request. That way, the scheduling device can update the actual state in the local dual-state record.

In some embodiments, the state machine deployed in the scheduling device may record and identify the dual-state of the target task. The state machine can be used for managing state transition in the life cycle of the target task. The expected state and the actual state can include at least one of the following: non-running state, running state, running ended state, running failed state, and running suspended state.

It is appreciated that after receiving the task synchronization request of the target device, the scheduling device may update the actual state of the target task in the local dual-state record according to the execution status of the target task indicated in the task synchronization request. The scheduling device can further determine that the target device has received the corresponding confirmation signal, and delete the local confirmation signal.

It is appreciated that the task status synchronization between the target device and the scheduling device may be performed, for example, in the following two manners: active synchronization, and passive synchronization.

Passive synchronization can refer to the following procedures. When the scheduling device receives an operating signal generated by an operation of a developer, the target device may send a heartbeat request to the scheduling device to pull the target task and the task content of the target task. After executing the task content in the target task, the target device can immediately send a task synchronization request to the scheduling device for task status synchronization.

Active synchronization can refer to the following procedures. The target device can actively send a task status calibration request to the scheduling device for task status synchronization. After the target device is restarted or recovers from a network interruption or fault, the target device may acquire task status of one or more tasks and generate the task status calibration request including the task status of the one or more tasks.

According to the above described embodiments in the present disclosure, the actual state and the target state of the target task can be marked by using the dual-state record. After the task synchronization request sent by the target device is received, the actual state of the target task can be updated, and the local confirmation signal can be deleted. The dual-state identification mechanism and the confirmation signal consumption mechanism can improve the processing stability and processing rate of the target task in the target device deployed by the scheduling device.

In some embodiments, the scheduling device can use the dual-state record to describe the current status of the target task, for example, an expected state and an actual state. When an upper-level package developer performs an operation on the target task in any state, the expected state is changed. The scheduling device may generate an operating signal according to the expected state, to control the target device to execute a corresponding operation according to the operating signal. After executing the corresponding operation, the target device may send the execution status of the target task to the scheduling device by sending a task synchronization request.

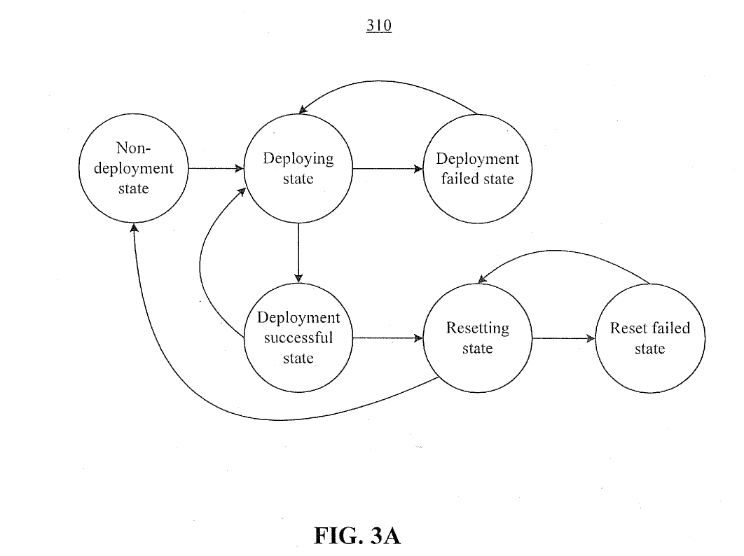

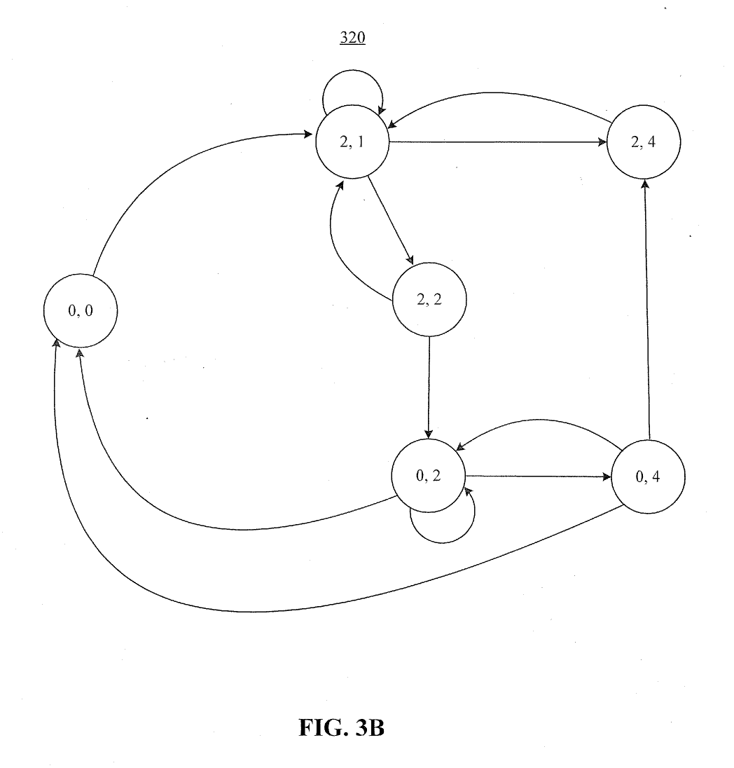

FIG. 3A is a schematic diagram 310 illustrating exemplary state transition of an optional state machine according to some embodiments of the present disclosure. As shown in FIG. 3A, the upper-level package developer can perceive the following states: non-deployment state, deploying state, deployment failed state, deployment successful state, resetting state, and reset failed state. The non-deployment state can be a reset successful state. The developer may be allowed to perform deployment and reset operations in any state.

In some embodiments, the state machine deployed in the scheduling device may record and identify the dual-state of the target task. The state machine can be used for managing state transition in the life cycle of the target task. The expected state and the actual state can include at least one of the following: non-running state, miming state, running ended state, running failed state, and running suspended state.

A transition relationship between the states having a connection relationship as shown in FIG. 3A can be as follows. When deployment is submitted, the state changes from the non-deployment state to the deploying state. If the deployment fails, the state changes from the deploying state to the deployment failed state. If a deployment attempt is made again, the state changes from the deployment failed state to the deploying state. If the deployment is successful, the state changes from the deploying state to the deployment successful state. If redeployment is performed, the state changes from the deployment successful state to the deploying state. If a reset operation is performed, the state changes from the deployment successful state to the resetting state. If the reset is successful, the state changes from the resetting state to the non-deployment state. If the reset fails, the state changes from the resetting state to the reset failed state. If a reset operation is performed again, the state changes from the reset failed state to the resetting state, to perform resetting again.

A state mapping table of some of the states perceivable by the upper-level package developer and included in the expected state and the actual state may be as shown in the exemplary Table 3 below. As shown in Table 3, a format used by the dual-state record (including the expected state and the actual state) corresponding to the task is represented as follows:

TABLE 3

| State description | State action scope | State code |
|---|---|---|
| deployment failed state | state changes to (2, 4) | 31 |
| deployment successful | target device, state changes | 2 |
| state (running state) | to (2, 2) | |
| deploying state | state changes to (2, 1) | 11 |
| stopping failed state | state changes to (0, 4) | 32 |
| stopping state | state changes to (0, 2) | 12 |
| non-deployment state | target device, state changes | 0 |
| (nonexistent state) | to (0, 0) | |
| non-running state | inside the scheduling device | 1 |
| | and the target device | |
| running ended state | configurable | 3 |
| running failed state | inside the scheduling device | 4 |
| | and the target device | |
| suspending state | configurable | 5 |

FIG. 3B is a schematic diagram 320 illustrating state transition of an exemplary state machine according to some embodiments of the present disclosure. As shown in FIG. 3B, an initial state of a task is (0, 0), that is, the expected state is non-deployment and the actual state is non-deployment, as described above. Examples of state transition are further provided below. When deployment is submitted, the state corresponding to the task changes to (2, 1). That is, the expected state is deployment successful and the actual state is non-running. When the deployment fails or the state is abnormal, the state corresponding to the task changes to (2, 4). Correspondingly, if a deployment attempt is made again, the state can directly change from (2, 4) to (2, 1). If the deployment is successful, the state corresponding to the task changes to (2, 2). If the task needs to be redeployed, the state corresponding to the task changes to (2, 1). If an undo operation is performed, the state corresponding to the task changes from (2, 1) to (0, 2). When the task is abnormal, the state corresponding to the task changes to (0, 4). When the state corresponding to the task is (2, 4), after the exception is deleted, the state corresponding to the task changes to (0, 4). When the state corresponding to the task is (0, 4), if a deployment attempt is made again, the state corresponding to the task changes to (0, 2). When the state corresponding to the task is (0, 2), if the undo operation is successful, the state corresponding to the task changes to (0, 0). When the state corresponding to the task is (0, 4), after the exception is deleted, the state corresponding to the task changes to (0, 0).

It is appreciated that, for state action scopes that are not explained in detail in herein, reference may be made to the specific mapping relationship between the state action scope and the state description, as shown in Table 3 above and described elsewhere in this disclosure.

It is appreciated that the state description of the target task depends on synchronization of the runtime environment. However, network congestion and low reliability of the runtime environment in the edge computing scenario may present the following problem. For example, the edge-side runtime environment may not return any information after a target task has been deployed on the target device. In that case, it cannot be determined whether the problem of the target task occurs in the task delivery phase, in the task execution phase of the runtime environment, or in the task status returning phase.

It is appreciated that through the dual-state identification mechanism provided in some embodiments of the present disclosure, the scheduling device may perform state description for the deployed target task at any moment. In the case where the target device does not respond to the execution status of the target task, the scheduling device may switch the execution status of the target task between the transient state and the final state. That way, the execution status of the target task will not be stuck in the transient state. A final state can indicate that the deployed target task is in the final state. A transient state can indicate that the deployed target task is in an intermediate state, for example, a state where an expected state of the target task is different from an actual state of the target task.

In some embodiments, after the generating a dual-state record corresponding to the target task, the method can further include the following procedure: determining whether the target task is abnormal by scanning the dual-state record. In some embodiments, the scanner in the scheduling device can be configured to scan the dual-state record to determine whether the target task is abnormal.

It is appreciated that when there are a large number of target devices to be monitored, the scanners may be grouped. A group of asynchronous scanner threads may be used to scan to-be-scanned objects managed by the scheduling device.

In some embodiments, after the target device successfully registers with the scheduling device, the cloud scheduling device may register the target device to a scanner thread. The scanner may monitor the various target devices and target tasks.

The scanner can include, but is not limited to, a scan thread group, a to-be-scanned object set, a scan logic function, an exception handling function, and the like. Scanning a to-be-scanned target object may be performed by the following processes: entrance manager and exit manager. The exit manager may detect normal exit and abnormal exit of the to-be-scanned object. In the case of abnormal exit, the exception handling function in the scanner may be triggered.

In some embodiments, determining whether the target task is abnormal by scanning the dual-state record may be implemented by performing the following procedures:

In step S302 (not shown in FIGS. 3A and 3B), detecting whether the expected state is the same as the actual state. If the expected state is different from the actual state throughout a preset period of time, an exception handling mechanism can be triggered.

In step S304 (not shown in FIGS. 3A and 3B), detecting whether the actual state indicates an abnormal state. If the actual state indicates an abnormal state, an exception handling mechanism can be triggered.

The abnormal state may include, but is not limited to, exceptions such as crash, network interruption, and the like. For example, when the actual state indicates a task exception and that it is a final state, it can be determined that the target task is abnormal, and an exception handling mechanism can be triggered. As another example, when the expected state is not consistent with the actual state, such as the expected state is different from the actual state throughout a preset period of time, it can be determined that the target task is abnormal, and an exception handling mechanism can be triggered.

Based on the above-described embodiments, whether the target device and the target task are abnormal can be detected. Corresponding exception handling according to detected abnormal situations can be performed. That way, the life cycle and the task status of the deployed target task can be effectively monitored.

It is appreciated that when the actual state is consistent with the expected state, or the actual state has stated that the task exception is the final state, a corresponding operation can be executed with respect to the target task in a transient state. For example, the scheduling device may discard the target task in the transient state or place it into a waiting queue.

In some embodiments, the scheduling device may check the target task in the transient state multiple times. When the scheduling device detects that the target device corresponding to the target task is normal, but the actual state of the target task is in a transient state for a preset period of time, the exception handling mechanism may be triggered. This can be performed by, for example, forcefully changing the actual state of the target task to failed, and generating a change signal for synchronization with the target device.

In some embodiments, when the scanner detects that the target device is disconnected, the scheduling device may detect a target task currently running in the target device. The scheduling device can generate a corresponding task snapshot, and record the task snapshot in the confirmation signal.

In some embodiments, when connection between the target device and the scheduling device is recovered, the scheduling device may synchronize the confirmation signal to a running container of the target device, to recover a target task that was executed in the target device before the failure. When a large number of target tasks are currently scheduled, the scheduling device may, for example, respond in batches to heartbeat requests sent by the target devices.

In some embodiments, the scanner may detect whether the actual state and the expected state in the dual states maintained for the task are consistent. If the expected state is different from the actual state throughout a preset period of time, for example, an intermediate state being sustained throughout the preset period of time (that is, the expected state being different from the actual state), an exception handling mechanism can be triggered. Alternatively, if the actual state indicates an abnormal state, the exception handling mechanism can be triggered.

In some embodiments, the scanner may further detect a state of an acknowledgment character returned by the scheduling device. For example, when the acknowledgment character has a state value of 1, it can indicate that the confirmation signal exists. When the acknowledgment character has a state value of 2, it can indicate that the confirmation signal has been synchronized to the target device.

In some embodiments, the scanner detects that the confirmation signal has been sent to the target device as a response to the heartbeat request, but the target device has not synchronized the execution status of the target task after the confirmation signal is received. In that case, the scheduling device may start an ACK exception handling procedure, and mark the current confirmation signal. That way, next time when the target device sends the heartbeat request, the scheduling device can attempt again to deliver the confirmation signal to the target device. If the target device fails to respond to the scheduling device for multiple times, the target device can be marked to be in the abnormal state.

In some embodiments, after every N times or after recovery from a fault, the target device may scan the execution status of the target tasks in the current node. The target device can add a task status set to the heartbeat request to be sent to the scheduling device next time. That is, the target device can send the task synchronization request to the scheduling device.

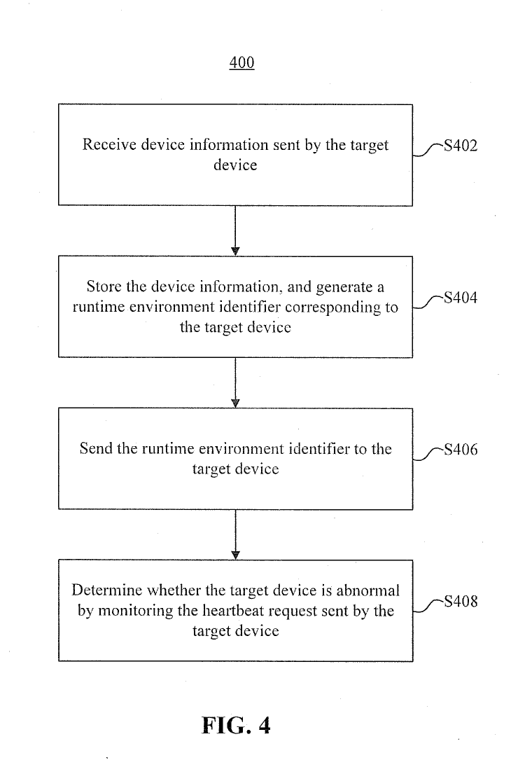

FIG. 4 is a flowchart of an exemplary task processing method 400 according to some embodiments of the present disclosure. As shown in FIG. 4, before the acquiring a target task, method 400 comprises the following procedures, steps S402-S408.

In step S402, receiving device information sent by the target device.

In step S404, storing the device information, and generating a runtime environment identifier corresponding to the target device.

In step S406, sending the runtime environment identifier to the target device.

In some embodiments, the device information can include information on at least one of the following: CPU, memory size, disk size, network link, SDK version number, execution engine information, address information, synchronization time interval, and configuration information.

Based on the above procedures, before the scheduling device acquires the target task, the target device may acquire the device information, and send the device information to the scheduling device. That way, registration of the target device with the scheduling device can be implemented.

In addition, the scheduling device may store the device information to achieve persistence of the target device information. The scheduling device may further generate a unique runtime environment identifier corresponding to the target device. The runtime environment identifier corresponding to the target device can be sent to the target device by, for example, returning ACK information.

In some embodiments, after step S406 of sending the runtime environment identifier to the target device, method 400 can further include the following procedure:

In step S408, determining whether the target device is abnormal by monitoring the heartbeat request sent by the target device.

In some embodiments, after the target device successfully registers with the scheduling device, the cloud scheduling device may register the target device to a scanner thread. The scanner may monitor each target device and may determine whether the target device is abnormal by, for example, monitoring whether a heartbeat of the target device is normal.

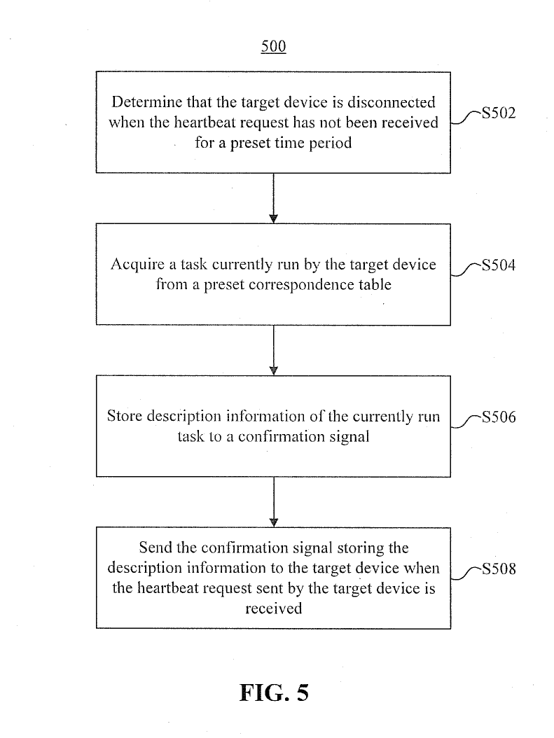

FIG. 5 is a flowchart of an exemplary task processing method 500 according to some embodiments of the present disclosure. As shown in FIG. 5, the process of determining whether the target device is abnormal by monitoring the heartbeat request sent by the target device can comprise the following procedures, steps S502-S508.

In step S502, determining that the target device is disconnected when the heartbeat request has not been received for a preset time period.

If after the preset time period or after a period longer than the preset time period, the scheduling device has not received the heartbeat request sent by the target device, it can be determined that the scheduling device has been disconnected with the target device. In that case, it can be determined that the target device is abnormal.

In step S504, acquiring a task currently run by the target device from a preset correspondence table.

In step S506, storing description information of the currently run task to a confirmation signal.

In step S508, sending the confirmation signal storing the description information to the target device when the heartbeat request sent by the target device is received.

Based on the above procedures, after detecting abnormality of the target device, the exception handling function can be called to perform corresponding processing. To facilitate this process, the scheduling device may acquire, from a prestored correspondence table, a task currently run by the target device according to the runtime environment identifier. The correspondence table may be, for example, a buffered table of a correspondence between the runtime environment identifier of the scheduling device and tasks run in the scheduling device. The scheduling device can further store description information of the currently run task to the confirmation signal. Subsequently, when receiving the heartbeat request sent by the target device, the scheduling device may send the confirmation signal storing the description information to the target device.

In some embodiments, the task processing method may further include the following procedures:

In step S510 (not shown in FIG. 5), receiving a task status calibration request sent by the target device. When the target device is restarted or recovers from a network interruption or fault, task status of one or more tasks can be acquired. The task status calibration request including the task status of the tasks can be generated based on the acquired status information.

In step S512 (not shown in FIG. 5), performing status calibration according to the task status calibration request.

Based on the above procedures, after the target device is restarted or recovers from a network interruption or fault, the target device may acquire the status of one or more tasks in the runtime environment. The target device can then generate a task status calibration request including the task status of the tasks, and send the status calibration request to the scheduling device. The status calibration request can be sent through an active synchronization interface. The scheduling device can perform status calibration according to the task status calibration request.

It is appreciated that status calibration can be performed by, for example, updating a pre-maintained status record by using the task status of the target tasks. In some embodiments, status calibration can also be performed by comparing the task status of the target tasks with the pre-maintained status record. The method for implementing the status calibration is not limited by embodiments described in the present disclosure. If the comparison result indicates that the states are different, status calibration information can be correspondingly returned to the target device.

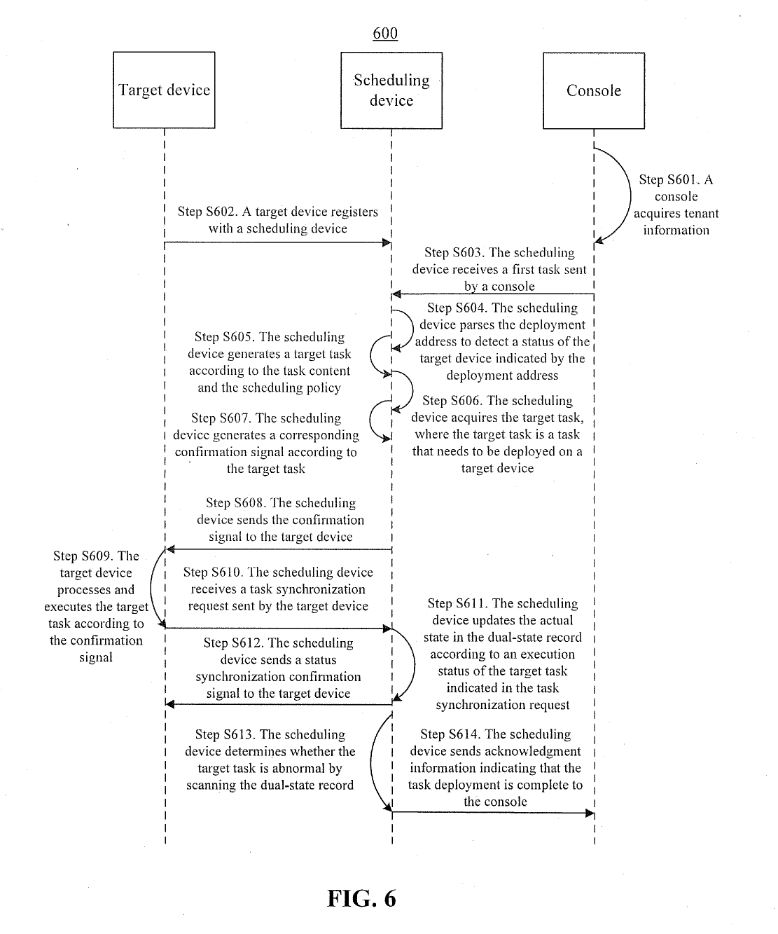

The implementation of an exemplary task processing method provided in the embodiments of the present disclosure is described below. FIG. 6 is a schematic interaction diagram of an exemplary task processing method 600 according to some embodiments of the present disclosure. As shown in FIG. 6, task processing method 600 may be implemented through the following procedures and interactions, steps S601-S614.

In step S601, a console acquires tenant information.

In some embodiments, the console can be an upper-level developer, for example, a registered developer. The console can acquire the tenant information based on account information that is authenticated in advance.

In step S602, a target device registers with a scheduling device.

In the process of registering with the scheduling device, the target device may, but not limited to, send device information to the scheduling device. The device information may include information regarding at least one of the following: CPU, memory size, disk size, network link, SDK version number, execution engine information, address information, synchronization time interval, and configuration information.

It is appreciated that before the scheduling device acquires the target task, the target device may acquire local device information. For example, the local device information an include information regarding CPU, memory size, disk size, network link, SDK version number, execution engine information, address information, synchronization time interval, configuration information, and the like. The target device can send the device information to the scheduling device, to implement registration at the scheduling device side.

It is appreciated that after receiving the device information, the scheduling device may store the device information to achieve persistence of the target device information, and generate a unique runtime environment identifier corresponding to the target device. The scheduling device can further send the runtime environment identifier corresponding to the target device to the target device by, for example, returning ACK information.

In some embodiments, the scheduling device may further initialize a scan thread, and determine whether the target task is abnormal by scanning the dual-state record as described above.

In step S603, the scheduling device receives a first task sent by a console.

In some embodiments, the scheduling device may receive the first task submitted by the console. When the console submits the first task to the scheduling device for deployment, information such as a scheduling policy, a deployment address, task content, and an execution engine in the first task can be specified.

In step S604, the scheduling device parses the deployment address to detect a status of the target device indicated by the deployment address.

The status of the target device may refer to, but is not limited to, a status of an execution node in the target device. When the target device is in the normal state, step S605 can be performed.

In some embodiments, the scheduling device parses the deployment address, and detects the status of the execution node of the target device. The scheduling device can further record a task snapshot of the target device, and check a format of the task content, to determine whether the status of the target device is normal.

In step S605, the scheduling device generates a target task according to the task content and the scheduling policy.

In some embodiments, the scheduling policy may be any one of the following scheduling policies: single-point scheduling, specified scheduling, full scheduling, distributed scheduling, and the like. If it is determined that the target device is in the normal state, the target task can be generated according to the task content and the scheduling policy.

In step S606, the scheduling device acquires the target task, where the target task is a task that needs to be deployed on a target device.

In some embodiments, the scheduling device may be a cloud scheduling device. The scheduling device can acquire a target task that needs to be deployed on an edge, and generate a corresponding confirmation signal according to the target task. When receiving a heartbeat request from a target device, the scheduling device can send the confirmation signal to the target device. The target device can execute the target task according to the task content.

In some embodiments, the target task can be a task that may be deployed and executed on the target device. For example, and may be, but is not limited to, a task relating to data filtering, format conversion, basic operations, scripts, rules, configuration, and applications. The target device may be an edge gateway device, a base station, or an edge cloud server. An edge-side execution node for providing a runtime environment for various execution engines may be deployed on the target device.

In step S607, the scheduling device generates a corresponding confirmation signal according to the target task.

The confirmation signal can include task content of the target task. The confirmation signal can further include at least one of the following: the task snapshot, the return code, and the consumption status. In some embodiments, the scheduling device may acquire the device information of the target device, and generate the corresponding confirmation signal according to the acquired target task and device information.

In some embodiments, the confirmation signal can include a response content field. The scheduling device may generate the corresponding confirmation signal according to the target task in the following manner: adding the task content to the response content field of the confirmation signal to obtain the confirmation signal. In some embodiments, the response content field may be a response content field Ack Content as shown above in Table 1. The confirmation signal may be obtained by adding the task content of the target task to the response content field Ack Content.

In some embodiments, when the target device is started, a runtime manager can load various execution engines. Each execution engine can have a respective name space. Execution engines implemented using different languages may be managed by means of inter-process communication. The runtime manager can send a broadcast to a data bus. After receiving the broadcast, each execution engine process can initiate an engine registration request to an address of the runtime manager.

In step S608, the scheduling device sends the confirmation signal to the target device. For example, when the heartbeat request of the target device is received, the scheduling device can send the confirmation signal to the target device. The target device can execute the target task according to the task content. In some embodiments, the heartbeat request can include information on at least one of the following: CPU usage, memory usage, disk usage, and execution status of the tasks.

In some embodiments, if the target device successfully registers with the scheduling device, the target device may locally start a heartbeat daemon thread. The heartbeat request can be sent to the scheduling device according to a fixed frequency of a preset heartbeat rate.

In some embodiments, the scheduling device may send the confirmation signal to the target device by performing, the following procedures: adding the confirmation signal to a data field of a heartbeat response; and sending the heartbeat response including the confirmation signal to the target device.

In some embodiments, upon receiving the heartbeat request sent by the target device, the scheduling device can detect whether a corresponding confirmation signal exists locally. If the corresponding confirmation signal exists, the scheduling device can add the confirmation signal to a heartbeat response of the current heartbeat request, and send the heartbeat response including the confirmation signal to the target device.

As described above, the scheduling device can add the task content to the response content field of the confirmation signal to obtain the confirmation signal. An exemplary data structure of the confirmation signal may be as shown above in Table 1. In addition, the confirmation signal may be added to the data of the heartbeat response. An exemplary data structure of the heartbeat response can be as shown in Table 2 above. It is appreciated that if the scheduling device detects that the corresponding confirmation signal does not exist locally, an acknowledgment character indicating that the heartbeat request has been received can be returned to the target device. The acknowledgement character can be used to acknowledge the reception of the heartbeat request of the target device.

In some embodiments, in addition to the pull mode described above, a push mode can also be applied. In the pull mode described above, after the scheduling device generates the corresponding confirmation signal according to the target task, the scheduling device can send the confirmation signal corresponding to the heartbeat request to the target device after receiving the heartbeat request of the target device. In the push mode, the scheduling device may actively push the confirmation signal to the target device after generating the confirmation signal, where the confirmation signal includes the task content of the target task. The push mode may be more applicable to some low-performance devices. One characteristic of the push mode is that it can reduce power consumption of low-performance devices.

In some embodiments, the confirmation signal including the task content may also be sent to the target device by using a combined protocol manner that combines the push mode and the pull mode. That way, a developer can switch between the modes according to actual implementation scenarios. For example, the combined protocol manner may be carried out by, but is not limited to: pushing a message to the target device after the scheduling device generates the confirmation signal, to instruct the target device to pull the confirmation signal carrying the target task from the scheduling device.

In step S609, the target device processes and executes the target task according to the confirmation signal. In some embodiments, after receiving the confirmation signal, the target device may parse the confirmation signal to obtain the task content of the target task included in the confirmation signal. The target device can complete the deployment of the target task, and execute the target task according to the task content.

In step S610, the scheduling device receives a task synchronization request sent by the target device.

In step S611, the scheduling device updates the actual state in the dual-state record according to an execution status of the target task indicated in the task synchronization request.

Based on the above procedures, upon receiving the confirmation signal, the target device may parse the task content of the target task carried in the confirmation signal. The target device can execute the target task, and send an execution status of the target task to the scheduling device through a task synchronization request. That way, the scheduling device can update the actual state in the local dual-state record.

In some embodiments, the state machine deployed in the scheduling device may record and identify the dual-state of the target task. The state machine can be used for managing state transition in the life cycle of the target task. The expected state and the actual state can include at least one of the following: non-running state, running state, running ended state, running failed state, and running suspended state.

It is appreciated that after receiving the task synchronization request of the target device, the scheduling device may update the actual state of the target task in the local dual-state record according to the execution status of the target task indicated in the task synchronization request. The scheduling device may determine that the target device has received the corresponding confirmation signal, and delete the local confirmation signal.

In step S612, the scheduling device sends a status synchronization confirmation signal to the target device.

In step S613, the scheduling device determines whether the target task is abnormal by scanning the dual-state record.

After generating a dual-state record corresponding to the target task, the above exemplary process may further include: determining whether the target task is abnormal by scanning the dual-state record. In some embodiments, determining whether the target task is abnormal by scanning the dual-state record may be implemented by performing the following procedures: detecting whether the expected state is the same as the actual state. If the expected state is different from the actual state throughout a preset period of time, an exception handling mechanism can be triggered. Alternatively, determining whether the target task is abnormal by scanning the dual-state record may be implemented by: detecting whether the actual state indicates an abnormal state. If the actual state indicates an abnormal state, an exception handling mechanism can be triggered.

The abnormal state may include, but is not limited to, exceptions such as crash, network interruption, and the like. For example, when the actual state indicates a task exception and that it is a final state, it can be determined that the target task is abnormal, and an exception handling mechanism can be triggered. As another example, when the expected state is not consistent with the actual state, such as the expected state is different from the actual state throughout a preset period of time, it can be determined that the target task is abnormal, and an exception handling mechanism can be triggered.

Based on the above-described embodiments, whether the target device and the target task are abnormal can be detected. Corresponding exception handling according to detected abnormal situations can be performed. That way, the life cycle and the task status of the deployed target task can be effectively monitored.

It is appreciated that when the actual state is consistent with the expected state, or the actual state has stated that the task exception is the final state, a corresponding operation can be executed with respect to the target task in a transient state. For example, the scheduling device may discard the target task in the transient state or place it into a waiting queue.

In some embodiments, the scheduling device may check the target task in the transient state multiple times. When detecting that the target device corresponding to the target task is normal but the actual state of the target task is in a transient state for a preset period of time, the scheduling device may trigger the exception handling mechanism. For example, the scheduling device may forcefully change the actual state of the target task to failed, and generate and synchronize a change signal to the target device.

In some embodiments, when the scanner detects that the target device is disconnected, the scheduling device may detect a target task currently run in the target device. The scheduling device can generate a corresponding task snapshot, and record the task snapshot in the confirmation signal.

In some embodiments, when connection between the target device and the scheduling device is recovered, the scheduling device may synchronize the confirmation signal to a running container of the target device, to recover a target task that is executed in the target device before the failure. When a large number of target tasks are currently scheduled, the scheduling device may respond in batches to heartbeat requests sent by the target devices.

In step S614, the scheduling device sends acknowledgment information indicating that the task deployment is complete to the console.

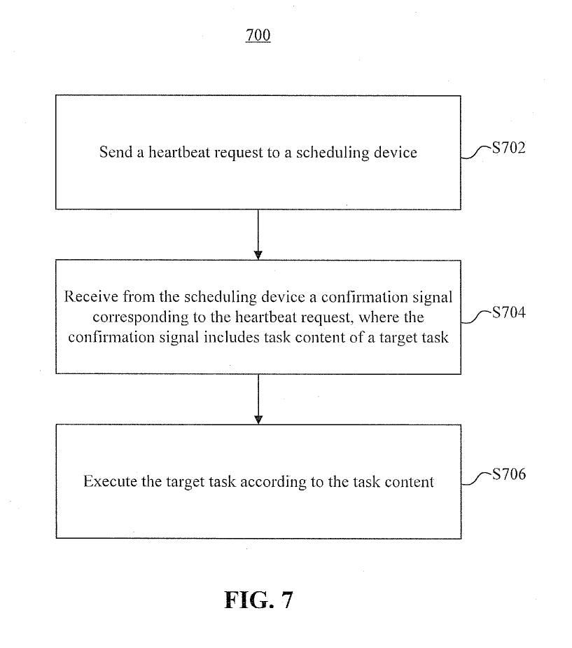

FIG. 7 is a flowchart of an exemplary task processing method 700, according to some embodiments of the present disclosure. The exemplary task processing method 700 can be performed in a runtime environment similar to that described above. It is appreciated that the task processing methods provided by the present disclosure may be run or executed in an edge computing scenario. According to some embodiments, the edge-side runtime environment, the task deployment status, the operating signal status and the like can be monitored and managed. That way, self-detection of and compensation for an exception on the edge gateway device can be performed. One advantage of the embodiments provided in the present disclosure is that the stability and data consistency of the edge-side runtime environment can be improved.

It should be appreciated that the embodiments of task processing methods provided by the present disclosure can be applied to emerging IoT fields such as smart industry, smart city, unmanned supermarket, and smart hotel. The solutions provided in the present disclosure can improve the task processing rate of edge computing and reduce the response time to a request from a device.

As shown in FIG. 7, the exemplary task processing method 700 provided by can include the following procedures, steps S702-S706.

In step S702, sending a heartbeat request to a scheduling device. It is appreciated that the methods provided in the present disclosure may be executed by a target device, which may be, for example, an edge gateway device, a base station, or an edge cloud server. The scheduling device may be a cloud scheduling device. An execution node for providing a time environment for various execution engines may be deployed on the target device.

In some embodiments, the heartbeat request can include information on at least one of the following: CPU usage, memory usage, disk usage, and execution status of the tasks. The heartbeat request may be a heartbeat packet sent by the target device to the scheduling device at fixed time intervals, for example, 30-40 s or another time interval. The heartbeat request may be used for indicating that currently the connection between the target device and the scheduling device is normal. Packet content of the heartbeat request is not limited by the embodiments described herein in the present disclosure. For example, the heartbeat request may be a null packet including only a header, as long as the packet can be used for keepalive and disconnection of a long connection.

In some embodiments, if the target device successfully registers with the scheduling device, the target device may locally start a heartbeat daemon thread. The heartbeat request to the scheduling device can be sent according to a fixed frequency of a preset heartbeat rate.

In step S704, receiving from the scheduling device a confirmation signal corresponding to the heartbeat request. The confirmation signal can include task content of a target task. The confirmation signal can be generated by the scheduling device after acquiring the target task.

In some embodiments, the target task can be a task that may be deployed and executed on the target device. The task may be, for example, a task relating to scripts, rules, configuration, applications, data filtering, format conversion, and basic operations.

In some embodiments, the scheduling device acquires a target task that needs to be deployed on an edge, and generates a corresponding confirmation signal according to the target task. When receiving a heartbeat request from a target device, the scheduling device can send the confirmation signal corresponding to the heartbeat request to the target device, so that the target device can execute the target task according to the task content.

Further, the scheduling device may acquire the device information of the target device. The corresponding confirmation signal can be generated according to the acquired target task and device info illation. In some embodiments, the confirmation signal can include a response content field. Generating a corresponding confirmation signal according to the target task can comprise: adding the task content to the response content field of the confirmation signal to obtain the confirmation signal.

In some embodiments, sending the confirmation signal to the target device may be implemented by performing the following procedures: adding the confirmation signal to a data field of a heartbeat response; and sending the heartbeat response including the confirmation signal to the target device.

In some embodiments, upon receiving the heartbeat request sent by the target device, the scheduling device can detect whether a corresponding confirmation signal exists locally. If the corresponding confirmation signal exists, the scheduling device can add the confirmation signal to a heartbeat response of the current heartbeat request. The scheduling device can send the heartbeat response including the confirmation signal to the target device. If the scheduling device detects that the corresponding confirmation signal does not exist locally, an acknowledgment character indicating that the heartbeat request has been received can be returned to the target device.

In some embodiments, in addition to the pull mode described above, a push mode can also be applied. In the pull mode described above, after the scheduling device generates the corresponding confirmation signal according to the target task, the scheduling device can send the confirmation signal corresponding to the heartbeat request to the target device after receiving the heartbeat request of the target device. In the push mode, the scheduling device may actively push the confirmation signal to the target device after generating the confirmation signal, where the confirmation signal includes the task content of the target task. The push mode may be more applicable to some low-performance devices. One characteristic of the push mode is that it can reduce power consumption of low-performance devices.

In some embodiments, the confirmation signal including the task content may also be sent to the target device by using a combined protocol manner that combines the push mode and the pull mode. That way, a developer can switch between the modes according to actual implementation scenarios. For example, the combined protocol manner may be carried out by, but is not limited to: pushing a message to the target device after the scheduling device generates the confirmation signal, to instruct the target device to pull the confirmation signal carrying the target task from the scheduling device.

In step S706, executing the target task according to the task content.

In some embodiments, after receiving the confirmation signal, the target device may parse the confirmation signal to obtain the task content of the target task included in the confirmation signal. The target device can then complete the deployment of the target task, and execute the target task according to the task content.

In some embodiments, after the executing the target task according to the task content, the target device can send a task synchronization request to the scheduling device. The task synchronization request can be used for indicating an execution status of the target task. The scheduling device can update an actual state in a dual-state record corresponding to the target task according to the execution status of the target task indicated in the task synchronization request. The dual-state record can include an expected state and an actual state. The expected state can be used for indicating a state of predicted execution of the target task. The actual state can be used for indicating a state of actual execution of the target task.

Based on the above described embodiments, a heartbeat request can be sent to a scheduling device. A confirmation signal corresponding to the heartbeat request can be received from the scheduling device. The confirmation signal can include task content of a target task. The confirmation signal can be generated by the scheduling device after acquiring the target task. The target task can be executed according to the task content.

By means of the solutions provided in the foregoing embodiment of the present disclosure, the task processing rate of edge computing and the stability of the edge operating system can be improved. The response time to a request from a device can be reduced by improving the task processing rate of edge computing. Therefore, the solutions provided herein can address the technical problem of deploying and running cloud computing logic and applications on an edge device close to the data source side.

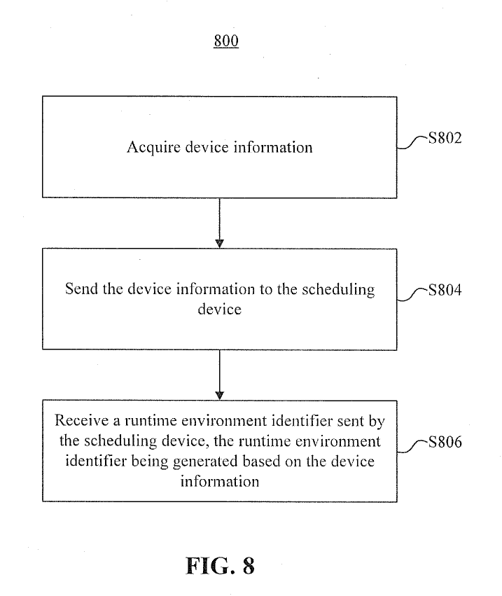

FIG. 8 is a flowchart of an exemplary optional task processing method 800 according to some embodiments of the present disclosure. The procedures in the exemplary method 800 can be implemented before step S702 (FIG. 7) of sending a heartbeat request to a scheduling device. As shown in FIG. 8, exemplary method 800 can comprise the following procedures, steps S802-S806.

In step S802, acquiring device information.

In step S804, sending the device information to the scheduling device. The scheduling device can store the device information and generate a corresponding runtime environment identifier.

In step S806, receiving a runtime environment identifier sent by the scheduling device, the runtime environment identifier being generated based on the device information.

In some embodiments, the device information can include at least one of the following: CPU, memory size, disk size, network link, SDK version number, execution engine information, address information, synchronization time interval, and configuration information.

In some embodiments, before the scheduling device acquires the target task, the target device may acquire local device information. For example, local device information can include information regarding CPU, memory size, disk size, network link, SDK version number, execution engine information, address information, synchronization time interval, configuration information, and the like. The target device can send the device information to the scheduling device, to implement registration with the scheduling device. The scheduling device can store the device information and generate a corresponding runtime environment identifier. Further, the scheduling device can store the device information to achieve persistence of the device information. The scheduling device can generate a unique runtime environment identifier corresponding to the target device. The scheduling device can send the runtime environment identifier corresponding to the target device to the target device by, for example, returning ACK information.

In some embodiments, after step S806 of receiving the runtime environment identifier sent by the scheduling device, exemplary method 800 can further include: sending a heartbeat request to the scheduling device according to a pre-configured frequency. The heartbeat request can include at least one of the following: CPU usage, memory usage, and disk usage.

In some embodiments, if the target device successfully registers with the scheduling device, the target device may locally start a heartbeat daemon thread. The heartbeat request to the scheduling device can be sent according to a fixed frequency of a preset heartbeat rate.

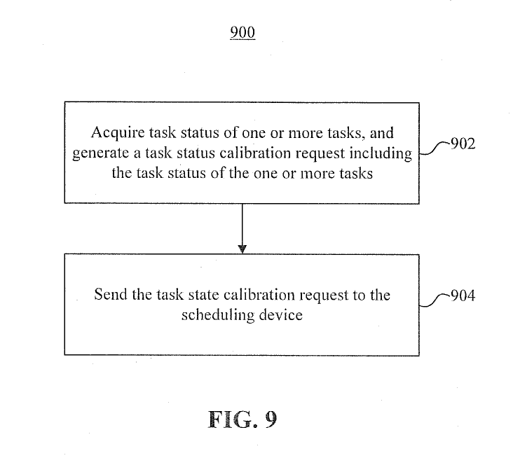

FIG. 9 is a flowchart of an exemplary task processing method 900 according to some embodiments of the present disclosure. As shown in FIG. 9, the exemplary task processing method 900 can include the following procedures: steps S902-S904.

In step S902, acquiring task status of one or more tasks, and generating a task status calibration request including the task status of the one or more tasks. This can be performed after a device restart or recovery from a network interruption or fault.

In step S904, sending the task status calibration request to the scheduling device. The scheduling device can perform status calibration according to the task status calibration request.

Based on above procedures, after the target device is restarted or recovers from a network interruption or fault, the target device may acquire the status of the tasks in the runtime environment. The target device can generate a task status calibration request including the task status of the tasks, and send the status calibration request to the scheduling device through, for example, an active synchronization interface. The scheduling device can perform status calibration according to the task status calibration request.

It is appreciated that status calibration can be performed by, for example, updating a pre-maintained status record by using the task status of the target tasks. In some embodiments, status calibration can also be performed by comparing the task status of the target tasks with the pre-maintained status record. The method for implementing the status calibration is not limited by embodiments described in the present disclosure. If the comparison result indicates that the states are different, status calibration information can be correspondingly returned to the target device.

It is appreciated that for implementations of the procedures described above, reference can be made to the related description provided elsewhere in this disclosure. Details will not be repeated here.

In a runtime environment similar to that described above, task processing methods are further provided. It should be appreciated that the task processing method provided by the present disclosure may be run or executed in an edge computing scenario. According to some embodiments, the edge-side runtime environment, the task deployment status, the operating signal status and the like can be monitored and managed. That way, self-detection of and compensation for an exception on the edge gateway device can be performed. One advantage of the embodiments provided in the present disclosure is that the stability and data consistency of the edge-side runtime environment can be improved.

It is appreciated that the embodiments of the task processing methods provided by the present disclosure can be applied to emerging IoT fields such as smart industry, smart city, unmanned supermarket, and smart hotel. The solutions provided herein can improve the task processing rate of edge computing, and reduce the response time to a request from a device.

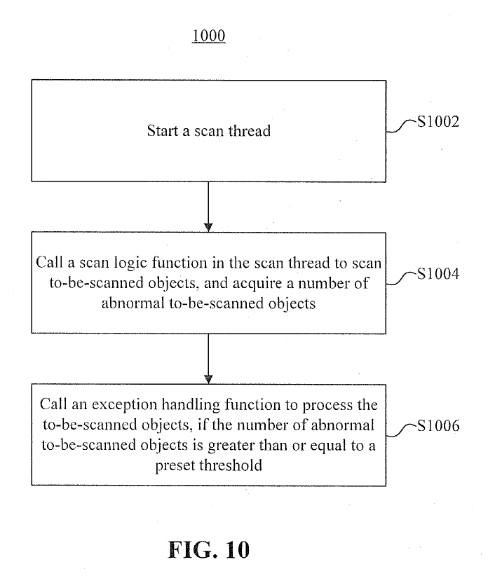

FIG. 10 is a flowchart of an exemplary task processing method 1000 according to some embodiments of the present disclosure. As shown in FIG. 10, task processing method 1000 can include the following procedures, steps S1002-S1006.

In step S1002, starting a scan thread. It is appreciated that the method embodiments described herein with reference to FIG. 10 may be executed by the scheduling device. To avoid the problem that one manager starts a plurality of scan threads, the scanner in the scheduling device can be used to scan the scan threads started by a manager. Before starting a scan thread, a running state of a current thread may be detected.

In step S1004, calling a scan logic function in the scan thread to scan to-be-scanned objects, and acquire a number of abnormal to-be-scanned objects. some embodiments, the to-be-scanned objects can include a target device or a target task. It should be appreciated that when there are a large number of target devices to be monitored, the scanners may be grouped. By calling the scan logic function, a group of asynchronous scanner threads may be used to scan to-be-scanned objects managed by the scheduling device.

In some embodiments, when the scheduling device is started, the scanner in the scheduling device may scan the scan threads started by the manager according to a buffered correspondence table. Before a scan thread is started, the running state of current threads may be detected. That way, the problem that one manager starts a plurality of scan threads can be avoided. In addition, if the buffered correspondence table is lost, the scan thread may be started via a registration monitoring platform procedure.

In some embodiments of the present disclosure, one scan thread can manage a group of to-be-scanned objects. At regular intervals, the scan logic function can be executed for the to-be-scanned object set. If it is determined that a current to-be-scanned object is abnormal, the scheduling device counts the number of abnormal to-be-scanned objects. The value of the count may represent the number of abnormal to-be-scanned objects. The value −1 can indicate that the to-be-scanned object is normal. 1 can indicate that the to-be-scanned object is abnormal. The lowest value of the count is 0. In some embodiments provided by the present disclosure, a scan thread may be named with its time interval as a suffix, to ensure that each scan thread has a different scan time interval.

In Step S1006, calling an exception handling function to process the to-be-scanned objects, if the number of abnormal to-be-scanned objects is greater than or equal to a preset threshold.

In some embodiments, abnormal to-be-scanned objects can be counted to obtain the number of abnormal to-be-scanned objects. The number of abnormal to-be-scanned objects can be compared with a preset threshold. The exception handling function can be called to process the to-be-scanned objects, if the number is greater than or equal to the preset threshold. Alternatively, no additional processing can be performed if the number is less than the preset threshold.

In addition, in some embodiments, after the target device successfully registers with the scheduling device, the cloud scheduling device may register the target device to a scanner thread. The scanner may monitor the various target devices and target tasks. The scanner can include, for example, a scan thread group, a to-be-scanned object set, a scan logic function, an exception handling function, and the like. Scanning a to-be-scanned target object may be performed by the following procedures: entrance manager and exit manager.

A to-be-scanned object may be allocated to one entrance manager according to a given rule. The allocation rule may vary with the actual implementation scenario and is not limited by the present disclosure. The exit manager can detect normal exit and abnormal exit of a to-be-scanned object. In the case of abnormal exit, the exception handling function in the scanner may be triggered.

Based on the above disclosure, in some embodiments, a scan thread can be started. With the scan thread, a scan logic function can be called to scan to-be-scanned objects, and a number of abnormal to-be-scanned objects can be acquired. An exception handling function can be called to process the to-be-scanned objects if the number of abnormal to-be-scanned objects is greater than or equal to a preset threshold. By detecting whether the target device and the target task are abnormal and performing corresponding exception handling according to the abnormal situations, the life cycle and the task status of the deployed target task can be effectively monitored.

By means of the solution provided in the foregoing embodiments of the present disclosure, the task processing rate of edge computing and the stability of the edge operating system can be increased. Further, the technical effect of reducing the response time to a request from a device can be achieved by increasing the task processing rate of edge computing. Therefore, the techniques provided in the present disclosure can address the technical problem of deploying and running cloud computing logic and applications on an edge device close to the data source side.

In some embodiments, when the to-be-scanned objects include the target device, the process of calling an exception handling function to process the to-be-scanned objects can include the following procedures.

In step S1007 (not shown in FIG. 10), acquiring a task currently run by the target device from a preset correspondence table.

In step S1008 (not shown in FIG. 10), storing description information of the currently run task to a confirmation signal

In step S1009 (not shown in FIG. 10), sending the confirmation signal storing the description information to the target device, when the heartbeat request sent by the target device is received.

Based on the above procedures, after detecting abnormality of the target device, the exception handling function can be called to perform corresponding processing. To facilitate this process, the scheduling device may acquire, from a prestored correspondence table, a task currently run by the target device according to the runtime environment identifier. The correspondence table may be, for example, a buffered table of a correspondence between the runtime environment identifier of the scheduling device and tasks run in the scheduling device. The scheduling device can further store description information of the currently run task to the confirmation signal. Subsequently, when receiving the heartbeat request sent by the target device, the scheduling device may send the confirmation signal storing the description information to the target device.

In addition, if after a preset time period, the scheduling device has not received the heartbeat request sent by the target device, it can be determined that the scheduling device has been disconnected with the target device. That is, it can be determined that the target device is abnormal. To detect the abnormality of the target device and call the exception handling function to perform corresponding processing, the abnormal target device may also be handled by using the above processing method.

In some embodiments, when registering with the cloud scheduling device, the target device enters the scanner of the scheduling device. The target device may abnormally exit after it is detected that abnormality exists with respect to the target device or the target task. The scan time interval may be, but not limited to, 2 times of a value obtained by rounding up a registered heart rate value of the targeting device. Other intervals may also be used, which is not limited by the present disclosure.

In addition, when an abnormality occurs in the target device, the abnormality may be processed by, for example, the following procedures: capturing a task snapshot of the target task run in the target device; generating an operating signal set; and waiting until the target device connects to the network or is restarted, to recover the target task.

In some embodiments, when the to-be-scanned objects include the target task, the process of calling an exception handling function to process the to-be-scanned objects may include the following procedures: setting an actual state in a dual-state record corresponding to the target task to an abnormal state. The dual-state record can include an expected state and an actual state. The expected state can be used for indicating a state of predicted execution of the target task. The actual state can be used for indicating a state of actual execution of the target task.

In some embodiments, the confirmation signal can include a response content field, and the scheduling device may generate the corresponding confirmation signal according to the target task in the following manner: adding the task content to the response content field of the confirmation signal to obtain the confirmation signal.

In some embodiments, the scheduling device may send the confirmation signal to the target device by performing the following procedures: adding the confirmation signal to a data field of a heartbeat response; and sending the heartbeat response including the confirmation signal to the target device.

In some embodiments, upon receiving the heartbeat request sent by the target device, the scheduling device can detect whether a corresponding confirmation signal exists locally. If the corresponding confirmation signal exists, the scheduling device can add the confirmation signal to a heartbeat response of the current heartbeat request. The scheduling device can send the heartbeat response including the confirmation signal to the target device. In some embodiments, upon receiving the confirmation signal, the target device may parse the task content of the target task carried in the confirmation signal, and execute the target task. The target device can further send an execution status of the target task to the scheduling device through a task synchronization request, so that the scheduling device can update the actual state in the local dual-state record.

In some embodiments, the state machine deployed in the scheduling device may record and identify the dual-state of the target task. The state machine can be used for managing state transition in the life cycle of the target task. The expected state and the actual state can include at least one of the following: non-running state, running state, running ended state, running failed state, and running suspended state.

In some embodiments, the scanner may detect whether the actual state and the expected state in the dual states maintained for the task are consistent. If the expected state is different from the actual state throughout a preset period of time, for example, an intermediate state being sustained throughout the preset period of time (that is, the expected state being different from the actual state), an exception handling mechanism can be triggered. Alternatively, if the actual state indicates an abnormal state, the exception handling mechanism can be triggered.

It is appreciated that after receiving the task synchronization request of the target device, the scheduling device may update the actual state of the target task in the local dual-state record according to the execution status of the target task indicated in the task synchronization request. The scheduling device may further determine that the target device has received the confirmation signal, and delete the local confirmation signal.

The abnormal state may include, but is not limited to, exceptions such as crash, network interruption, and the like. For example, when the actual state indicates a task exception and that it is a final state, it can be determined that the target task is abnormal, and an exception handling mechanism can be triggered. As another example, when the expected state is not consistent with the actual state, such as the expected state is different from the actual state throughout a preset period of time, it can be determined that the target task is abnormal, and an exception handling mechanism can be triggered.

It is appreciated that when the actual state is consistent with the expected state, or the actual state has stated that the task exception is the final state, a corresponding operation can be executed with respect to the target task in a transient state. For example, the scheduling device may discard the target task in the transient state or place it into a waiting queue.

In some embodiments, the scheduling device may check the target task in the transient state multiple times. When the scheduling device detects that the target device corresponding to the target task is normal, but the actual state of the target task is in a transient state for a preset period of time, the exception handling mechanism may be triggered. This can be performed by, for example, forcefully changing the actual state of the target task to failed, and generating a change signal for synchronization with the target device.

In some embodiments, when the target task is pulled by the target device, the target task enters the scanner of the scheduling device, and exits after the status of the target task is returned or the exception handling is completed. The scan time interval may be a fixed time interval.

In addition, when an abnormality occurs with respect to the target task, the following procedures may be performed. If it is determined that a link of the runtime environment is normal, but the target task has been in the intermediate state for a period of time, the state can be changed to the final state. That is, it can be determined that currently the target task is in the abnormal state.

It is appreciated that for implementations of the procedures described above, reference can be made to the related description provided elsewhere in this disclosure. Details will not be repeated here.

It is appreciated, for ease of description, some method embodiments described above may be described as a series of action combinations. However, those skilled in the art would appreciate that the present disclosure is not limited by the orders of action described here. The procedures and steps may be performed in other orders or simultaneously in some other embodiments according to the present disclosure. Further, it is appreciated that the embodiments described in the present disclosure are exemplary only. The procedures and modules described herein may be modified or adjusted in actual implementations.

Based on the foregoing descriptions some exemplary embodiments, those skilled in the art may appreciate that the methods according to the above described embodiments may be implemented by software plus a necessary universal hardware platform. The methods may also be implemented by hardware. Based on such understanding, the technical solutions of the present disclosure may be embodied in the form of a software product. The software product may be stored in a storage medium, such as a ROM/RAM, a magnetic disk, or an optical disc. The storage medium may include several instructions that enable a terminal device to perform the methods provided in the embodiments of the present disclosure. The terminal device may be, for example, a mobile phone, a computer, a server, a network device or the like.

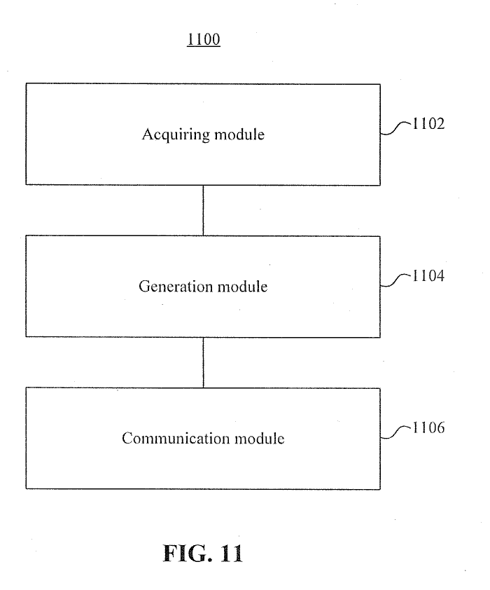

According to some embodiments of the present disclosure, task processing apparatus configured to implement task processing methods are further provided. FIG. 11 is a schematic structural diagram of an exemplary task processing apparatus 1100 according to some embodiments of the present disclosure. As shown in FIG. 11, the exemplary apparatus 1100 can include an acquiring module 1102, a generation module 1104, and a communication module 1106.

Acquiring module 1102 can be configured to acquire a target task, where the target task is a task that needs to be deployed on a target device.

Generation module 1104 can be configured to generate a corresponding confirmation signal according to the target task, where the confirmation signal includes task content of the target task.

Communication module 1106 can be configured to send the confirmation signal to the target device, when a heartbeat request from the target device is received. The target device can execute the target task according to the task content.

It should be appreciated that acquiring module 1102, generation module 1104, and communication module 1106 can perform similar procedures described above with reference to FIG. 2. The above modules can be applied in similar application scenarios as those described above with reference to FIG. 2. Further, above modules may, as a part of the apparatus, run in a computing device, such as computer terminal 100 described above with reference to FIG. 1. It is appreciated that for implementations of the procedures described above, reference can be made to the related description provided elsewhere in this disclosure. Details will not be repeated here.

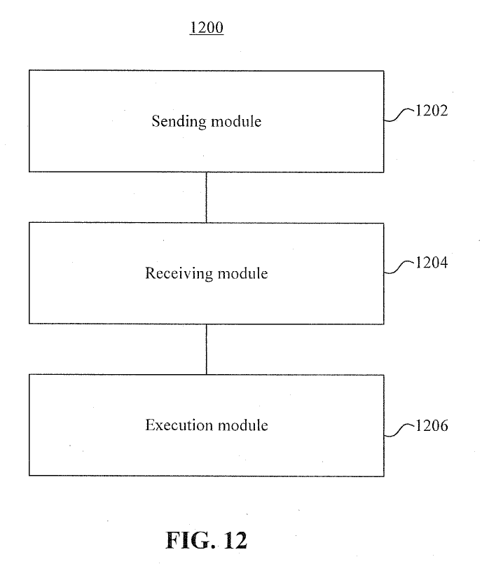

FIG. 12 is a schematic structural diagram of an exemplary task processing apparatus 1200 according to some embodiments of the present disclosure. As shown in FIG. 12, the exemplary task processing apparatus 1200 can include a sending module 1202, a receiving module 1204, and an execution module 1206.

Sending module 1202 can be configured to send a heartbeat request to a scheduling device.

Receiving module 1204 can be configured to receive from the scheduling device a confirmation signal corresponding to the heartbeat request. The confirmation signal can include task content of a target task, and the confirmation signal can be generated by the scheduling device after acquiring the target task.

Execution module 1206 can be configured to execute the target task according to the task content.

It should be appreciated that sending module 1202, receiving module 1204, and execution module 1206 can perform similar procedures described above with reference to FIG. 7. The above modules can be applied in similar application scenarios as those described above with reference to FIG. 7. Further, above modules may, as a part of the apparatus, run in a computing device, such as computer terminal 100 described above with reference to FIG. 1. It is appreciated that for implementations of the procedures described above, reference can be made to the related description provided elsewhere in this disclosure. Details will not be repeated here.

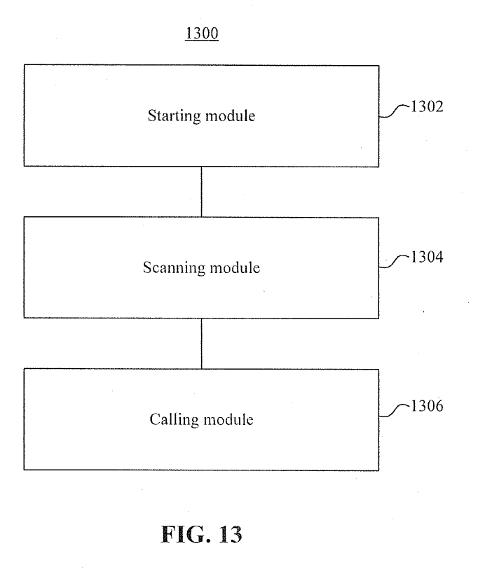

FIG. 13 is a schematic structural diagram of an exemplary task processing apparatus 1300 according to some embodiments of the present disclosure. As shown in FIG. 13, the exemplary task processing apparatus can include: a starting module 1302, a scanning module 1304, and a calling module 1306.

Starting module 1302 can be configured to start a scan thread.

Scanning module 1304 can be configured to call a scan logic function in the scan thread to scan to-be-scanned objects, and acquire a number of abnormal to-be-scanned objects.

Calling module 1306 can be configured to call an exception handling function to process the to-be-scanned objects, if the number is greater than or equal to a preset threshold.

It should be appreciated that starting module 1302, the scanning module 1304, and calling module 1306 can perform similar procedures described above with reference to FIG. 10. The above modules can be applied in similar application scenarios as those described above with reference to FIG. 10. Further, above modules may, as a part of the apparatus, run in a computing device, such as computer terminal 100 described above with reference to FIG. 1. It is appreciated that for implementations of the procedures described above, reference can be made to the related description provided elsewhere in this disclosure. Details will not be repeated here.

According to some embodiments of the present disclosure, task processing systems are further provided. The task processing systems may include at least one of the task processing apparatus as described above with reference to FIGS. 11-13.

According to some embodiments of the present disclosure, a task processing system may include a task processing apparatus as described above with reference to FIG. 11, which is configured to implement task processing methods. The task processing apparatus can include: an acquiring module 1102, a generation module 1104, and a communication module 1106, as shown in FIG. 11. Acquiring module 1102 can be configured to acquire a target task, where the target task is a task that needs to be deployed on a target device. Generation module 1104 can be configured to generate a corresponding confirmation signal according to the target task, where the confirmation signal includes task content of the target task. Communication module 1106 can be configured to send the confirmation signal to the target device, when a heartbeat request from the target device is received. The target device can execute the target task according to the task content.

According to some embodiments of the present disclosure, a task processing system can include a task processing apparatus as described above with reference to FIG. 12, which is configured to implement task processing methods. The task processing apparatus can include a sending module 1202, a receiving module 1204, and an execution module 1206, as shown in FIG. 12. Sending module 1202 can be configured to send a heartbeat request to a scheduling device. Receiving module 1204 can be configured to receive from the scheduling device a confirmation signal corresponding to the heartbeat request. The confirmation signal can include task content of a target task, and the confirmation signal can be generated by the scheduling device after acquiring the target task. Execution module 1206 can be configured to execute the target task according to the task content.

According to some embodiments of the present disclosure, a task processing system can include a task processing apparatus as described above with reference to FIG. 13, which is configured to implement task processing methods. The task processing apparatus can include a starting module 1302, a scanning module 1304, and a calling module 1306. Starting module 1302 can be configured to start a scan thread. Scanning module 1304 can be configured to call a scan logic function in the scan thread to scan to-be-scanned objects, and acquire a number of abnormal to-be-scanned objects. Calling module 1306 can be configured to call an exception handling function to process the to-be-scanned objects, if the number is greater than or equal to a preset threshold.

It is appreciated that for implementations of the procedures described above, reference can be made to the related description provided elsewhere in this disclosure. Details will not be repeated here.

According to some embodiments of the present disclosure, computer terminals are further provided. The computer terminal may be a computer terminal device in a computer terminal group. In some embodiments, the computer terminal may also be replaced with a terminal device, such as a mobile terminal. Further, the computer terminal may be located in at least one of multiple network devices in a computer network.

The method embodiments descried above in the present disclosure may be executed in a mobile terminal, a computer terminal, or a similar computing device. It should be appreciated that in some embodiments, computer terminal 100 as shown in FIG. 1 may include hardware elements such as a circuit, or software elements including computer code stored on a computer readable medium. Computer terminal 100 may also include a combination of hardware and software elements. It is appreciated that FIG. 1 is merely an example of a particular implementation scenario. The structure shown in FIG. 1 is not intended to limit the types of components that may exist in the computer terminal 10.

In some embodiments, the above described computer terminal, or a processor of the computer terminal, may execute program code corresponding to the procedures for performing a task processing method. The procedures may include: acquiring a target task, the target task being a task that needs to be deployed on a target device; generating a corresponding confirmation signal according to the target task, the confirmation signal including task content of the target task; and sending the confirmation signal to the target device, when a heartbeat request from the target device is received. The target device can execute the target task according to the task content.

In some embodiments, a processor of the computer terminal may further be configured to execute program code for performing the following procedures: generating a dual-state record corresponding to the target task. The dual-state record can include an expected state and an actual state. The expected state can be used for indicating a state of predicted execution of the target task. The actual state can be used for indicating a state of actual execution of the target task.

In some embodiments, the processor may further be configured to execute program code to perform the following procedures: receiving a task synchronization request sent by the target device; and updating the actual state in the dual-state record according to an execution status of the target task indicated in the task synchronization request.

In some embodiments, the processor may further be configured to execute program code to perform the following procedures: determining whether the target task is abnormal by scanning the dual-state record.

In some embodiments, the processor may further be configured to execute program code to perform the following procedures: detecting whether the expected state is the same as the actual state. If the expected state is different from the actual state throughout a preset period of time, an exception handling mechanism can be triggered. Further, the processor can be further configured to detect whether the actual state indicates an abnormal state. If the actual state indicates an abnormal state, an exception handling mechanism can be triggered.

In some embodiments, the processor may further be configured to execute program code to perform the following procedures: receiving a first task sent by a console, where the first task includes a scheduling policy, a deployment address, and task content; parsing the deployment address to detect a status of the target device indicated by the deployment address; and generating the target task according to the task content and the scheduling policy if the target device is in a normal state.

In some embodiments, the processor may further be configured to execute program code to perform the following procedures: receiving device information sent by the target device; storing the device information, and generating a runtime environment identifier corresponding to the target device; and sending the runtime environment identifier to the target device.

In some embodiments, the processor may further be configured to execute program code to perform the following procedures: acquiring the device information; and generating the confirmation signal according to the target task and the device information. The confirmation signal can further include at least one of the following: a task snapshot, a return code, and a consumption status.

In some embodiments, the processor may further be configured to execute program code to perform the following procedures: determining whether the target device is abnormal by monitoring the heartbeat request sent by the target device.

In some embodiments, the processor may further be configured to execute program code to perform the following procedures: determining that the target device has been disconnected when the heartbeat request has not been received for a preset time period. The process can be configured to acquire a task currently run by the target device from a preset correspondence table, and store description information of the currently run task to a confirmation signal. The confirmation signal storing the description information can be sent to the target device when the heartbeat request sent by the target device is received.

In some embodiments, the processor may further be configured to execute program code to perform the following procedures: receiving a task, status calibration request sent by the target device. When the target device is restarted or recovers from a network interruption or fault, task status of the tasks can be acquired. The task status calibration request including the task status of the tasks can be generated. Status calibration can be performed according to the task status calibration request.

In some embodiments, the processor may further be configured to execute program code to perform the following procedures: sending a heartbeat request to a scheduling device; receiving from the scheduling device a confirmation signal corresponding to the heartbeat request, the confirmation signal including task content of a target task; and executing the target task according to the task content. The confirmation signal can be generated by the scheduling device after acquiring the target task.

In some embodiments, the processor may further be configured to execute program code to perform the following procedures: sending a task synchronization request to the scheduling device. The task synchronization request can be used for indicating an execution status of the target task. The scheduling device can update an actual state in a dual-state record corresponding to the target task, according to the execution status of the target task indicated in the task synchronization request. The dual-state record can include an expected state and an actual state. The expected state can be used for indicating a state of predicted execution of the target task. The actual state can be used for indicating a state of actual execution of the target task.

In some embodiments, the processor may further be configured to execute program code to perform the following procedures: acquiring device information; and sending the device information to the scheduling device. The scheduling device can store the device information, and generate a corresponding runtime environment identifier. The processor can be further configured to receive the runtime environment identifier sent by the scheduling device.

In some embodiments, the processor may further be configured to execute program code to perform the following procedures: sending a heartbeat request to the scheduling device according to a pre-configured frequency. The heartbeat request can include information on at least one of the following: CPU usage, memory usage, and disk usage.

In some embodiments, the processor may further be configured to execute program code to perform the following procedures: after a restart or recovery from a network interruption or fault, acquiring task status of one or more tasks. A task status calibration request can be generated, including the task status of the tasks. The task status calibration request can be sent to the scheduling device, so that the scheduling device can perform status calibration according to the task status calibration request.

In some embodiments, the processor may further be configured to execute program code to perform the following procedures: starting a scan thread; calling a scan logic function in the scan thread to scan to-be-scanned objects; and acquiring a number of abnormal to-be-scanned objects. An exception handling function can be called to process the to-be-scanned objects, if the number is greater than or equal to a preset threshold.

In some embodiments, the processor may further be configured to execute program code to perform the following procedures: acquiring a task currently run by the target device from a preset correspondence table; storing description information of the currently run task to a confirmation signal; and sending the confirmation signal storing the description information to the target device when the heartbeat request sent by the target device is received.

In some embodiments, the processor may further be configured to execute program code to perform the following procedures: setting an actual state in a dual-state record corresponding to the target task to an abnormal state. The dual-state record can include an expected state and an actual state. The expected state can be used for indicating a state of predicted execution of the target task. The actual state can be used for indicating a state of actual execution of the target task.

Those of ordinary skill in the art would appreciate that the structure shown in FIG. 1 is merely schematic. The computer terminal described with reference to FIG. 1 may also be a terminal device such as a smart phone. For example, the device can be an Android phone, an iOS phone, a tablet computer, a handheld computer, a Mobile Internet Devices (MID), a PAD, and the like. FIG. 1 does not limit the structure of the above electronic apparatus. For example, computer terminal 100 may include more or fewer components than those shown in FIG. 1, such as a network interface and a display apparatus. Computer terminal 100 may also have a configuration different from that shown in FIG. 1.

It is appreciated that all or part of the procedures described above in the method embodiments may be implemented through a program instructing hardware associated with a terminal device. The program may be stored in a computer readable storage medium. The storage medium may include: a flash memory disk, a Read-Only Memory (ROM), a Random Access Memory (RAM), a magnetic disk, an optical disc, or the like.

According to some embodiments of the present disclosure, storage media are further provided. For example, the storage media may be configured to store program code corresponding to the task processing methods as described above. In some embodiments, Optionally, the storage media may be located in any computer terminal in a computer terminal group within a computer network, or located in any mobile terminal in a mobile terminal group.

In some embodiments, a storage medium can be configured to store program code corresponding to the following procedures: acquiring a target task, the target task being a task that needs to be deployed on a target device; generating a corresponding confirmation signal according to the target task, the confirmation signal including task content of the target task; and sending the confirmation signal to the target device, when a heartbeat request from the target device is received. The target device can execute the target task according to the task content.

In some embodiments, a storage medium can be configured to store program code corresponding to the following procedures: generating a dual-state record corresponding to the target task. The dual-state record can include an expected state and an actual state. The expected state can be used for indicating a state of predicted execution of the target task. The actual state can be used for indicating a state of actual execution of the target task.

In some embodiments, a storage medium can be configured to store program code corresponding to the following procedures: receiving a task synchronization request sent by the target device; and updating the actual state in the dual-state record according to an execution status of the target task indicated in the task synchronization request.

In some embodiments, a storage medium can be configured to store program code corresponding to the following procedures: determining whether the target task is abnormal by scanning the dual-state record.

In some embodiments, a storage medium can be configured to store program code corresponding to the following procedures: detecting whether the expected state is the same as the actual state. If the expected state is different from the actual state throughout a preset period of time, an exception handling mechanism can be triggered. Further, the processor can be further configured to detect whether the actual state indicates an abnormal state. If the actual state indicates an abnormal state, an exception handling mechanism can be triggered.

In some embodiments, a storage medium can be configured to store program code corresponding to the following procedures: receiving a first task sent by a console, where the first task includes a scheduling policy, a deployment address, and task content; parsing the deployment address to detect a status of the target device indicated by the deployment address; and generating the target task according to the task content and the scheduling policy if the target device is in a normal state.

In some embodiments, a storage medium can be configured to store program code corresponding to the following procedures: receiving device information sent by the target device; storing the device information, and generating a runtime environment identifier corresponding to the target device; and sending the runtime environment identifier to the target device.

In some embodiments, a storage medium can be configured to store program code corresponding to the following procedures: acquiring the device information; and generating the confirmation signal according to the target task and the device information. The confirmation signal can further include at least one of the following: a task snapshot, a return code, and a consumption status.

In some embodiments, a storage medium can be configured to store program code corresponding to the following procedures: determining whether the target device is abnormal by monitoring the heartbeat request sent by the target device.

In some embodiments, a storage medium can be configured to store program code corresponding to the following procedures: determining that the target device has been disconnected when the heartbeat request has not been received for a preset time period. The storage medium can be further configured to store program code corresponding to the following procedures: acquiring a task currently run by the target device from a preset correspondence table; and storing description information of the currently run task to a confirmation signal. The confirmation signal storing the description information can be sent to the target device when the heartbeat request sent by the target device is received.

In some embodiments, a storage medium can be configured to store program code corresponding to the following procedures: receiving a task status calibration request sent by the target device. When the target device is restarted or recovers from a network interruption or fault, task status of one or more tasks can be acquired. The task status calibration request including the task status of the tasks can be generated. Status calibration can be performed according to the task status calibration request.

In some embodiments, a storage medium can be configured to store program code corresponding to the following procedures: sending a heartbeat request to a scheduling device; receiving from the scheduling device a confirmation signal corresponding to the heartbeat request, the confirmation signal including task content of a target task; and executing the target task according to the task content. The confirmation signal can be generated by the scheduling device after acquiring the target task.

In some embodiments, a storage medium can be configured to store program code corresponding to the following procedures: sending a task synchronization request to the scheduling device. The task synchronization request can be used for indicating an execution status of the target task. The scheduling device can update an actual state in a dual-state record corresponding to the target task, according to the execution status of the target task indicated in the task synchronization request. The dual-state record can include an expected state and an actual state. The expected state can be used for indicating a state of predicted execution of the target task. The actual state can be used for indicating a state of actual execution of the target task.

In some embodiments, a storage medium can be configured to store program code corresponding to the following procedures: acquiring device information; and sending the device information to the scheduling device. The scheduling device can store the device information and generate a corresponding runtime environment identifier. The runtime environment identifier can be returned by the scheduling device.

In some embodiments, a storage medium can be configured to store program code corresponding to the following procedures: sending a heartbeat request to the scheduling device according to a pre-configured frequency. The heartbeat request can include information on at least one of the following: CPU usage, memory usage, and disk usage.

In some embodiments, a storage medium can be configured to store program code corresponding to the following procedures: after a restart or recovery from a network interruption or fault, acquiring task status of one or more tasks. A task status calibration request can be generated, including the task status of the tasks. The task status calibration request can be sent to the scheduling device, so that the scheduling device can perform status calibration according to the task status calibration request.

In some embodiments, a storage medium can be configured to store program code corresponding to the following procedures: starting a scan thread; calling a scan logic function in the scan thread to scan to-be-scanned objects; and acquiring a number of abnormal to-be-scanned objects. An exception handling function can be called to process the to-be-scanned objects, if the number is greater than or equal to a preset threshold.

In some embodiments, a storage medium can be configured to store program code corresponding to the following procedures: acquiring a task currently run by the target device from a preset correspondence table; storing description information of the currently nm task to a confirmation signal; and sending the confirmation signal storing the description information to the target device when the heartbeat request sent by the target device is received.

In some embodiments, a storage medium can be configured to store program code corresponding to the following procedures: setting an actual state in a dual-state record corresponding to the target task to an abnormal state. The dual-state record can include an expected state and an actual state. The expected state can be used for indicating a state of predicted execution of the target task. The actual state can be used for indicating a state of actual execution of the target task.

In the above description, the reference numerals used herein are merely used for description purpose. The numbers do not indicate any mandatory order. Further, different embodiments may focus on different aspects of the present disclosure. For parts that are not described in detail in some embodiments, reference may be made to related descriptions in other embodiments.

Based on the above described embodiments provided in the present disclosure, it is appreciated that the technical solutions may be implemented in other manners. For example, the apparatus embodiments described above is merely schematic. The division of units is merely exemplary division of logic functions. In actual implementation, there may be other division manners applicable to a particular scenario. Further, multiple units or components may be combined or may be integrated into another system. Some features may be omitted or modified in some embodiments. In addition, the displayed or discussed coupling, direct coupling, or communication connection between different units or modules may be implemented by using some interfaces. Indirect coupling or communication connection between units or modules may be achieved in an electrical form or other forms.

Units described as separated parts may or may not be physically separated. Parts described as units may or may not be physical units. The parts or units may be located at the same place, or may be distributed to multiple network units. The objectives and solutions of the present disclosure may be implemented by selecting a part of or all units described in the above embodiments according to actual requirements.

In addition, various function units described in the embodiments of the present disclosure can be integrated into one processing unit. Each unit may also exist alone physically, and two or more units may also be integrated into one unit. The integrated unit may be implemented in a form of hardware and may also be implemented in a form of a software function unit.

The integrated unit, if implemented in a form of a software functional unit and sold or used as an independent product, may be stored in a computer readable storage medium. Based on such understanding, the technical solutions of the present disclosure, or a part thereof, may be implemented in a form of a software product. The computer software product may be stored in a storage medium. The storage medium may include several instructions for instructing a computer device to execute all or a part of the procedures in the method embodiments of the present disclosure. The computer device may be a personal computer, a server, a network device, or the like. The storage medium can include: a USB flash disk, a Read-Only Memory (ROM), a Random Access Memory (RAM), a mobile hard disk, a magnetic disk, an optical disc, or other media that can store program codes. For example, the storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

It is appreciated that the above descriptions are only exemplary embodiments provided in the present disclosure. Consistent with the present disclosure, those of ordinary skill in the art may incorporate variations and modifications in actual implementation, without departing from the principles of the present disclosure. Such variations and modifications shall all fall within the protection scope of the present disclosure.

1. A task processing method performed by a scheduling device, the method comprising:
acquiring a target task to be deployed to a target device;
generating a confirmation signal according to the target task, the confirmation signal indicating task content of the target task; and
in response to a heartbeat request being received from the target device, sending the confirmation signal to the target device.

2. (canceled)

3. The method according to claim 1, wherein the target device is an edge device, the method further comprising:
generating a dual-state record corresponding to the target task, the dual-state record including an expected state and an actual state of the target task;
receiving a task synchronization request sent by the target device, the task synchronization request indicating an execution status of the target task; and
updating the dual-state record according to the execution status.

4. (canceled)

5. The method according to claim 3, wherein whether the target task is abnormal is determined by scanning the dual state record, the method further comprising:
determining whether the expected state is the same as the actual state, and in response to the expected state being different from the actual state throughout a preset period of time, triggering an exception handling mechanism; or
determining whether the actual state indicates an abnormal state, and in response to the actual state indicating an abnormal state, triggering the exception handling mechanism.

6. The method according to claim 1, wherein the acquiring the target task comprises:
receiving a first task sent by a console, the first task including a scheduling policy, a deployment address, and content of the first task, the deployment address pointing to the target device;
parsing the deployment address and determining a state of the target device based on the deployment address; and
in response to the target device being in a normal state, generating the target task according to the scheduling policy and the content of the first task.

7. The method according to claim 1, wherein before the acquiring the target task, the method further comprises:
receiving device information sent by the target device;
generating, based on the device information, a runtime environment identifier corresponding to the target device; and
sending the runtime environment identifier to the target device.

8. The method according to claim 7, wherein the generating the confirmation signal according to the target task comprises:
generating the confirmation signal according to the target task and the device information.

9. The method according to claim 7, wherein the device information includes information of at least one of the following: a central processing unit (CPU), a memory size, a disk size, a network link, a software development kit (SDK) version number, an execution engine, an address, a synchronization time interval, and configuration of the target device.

10. The method according to claim 1, further comprising:
determining whether the target device is abnormal by monitoring the heartbeat request sent by the target device.

11. The method according to claim 10, further comprising:
in response to the heartbeat request not being received for a preset time period, determining that the target device is disconnected;
acquiring, from a preset correspondence table, a first task currently running on the target device;
storing description information of the first task to the confirmation signal; and
in response to a next heartbeat request being received from the target device, sending the confirmation signal to the target device.

12. The method according to claim 1, wherein the confirmation signal includes a response content field, and the generating the confirmation signal according to the target task comprises:
adding the task content to the response content field.

13. The method according to claim 1, wherein the sending the confirmation signal to the target device comprises:
adding the confirmation signal to a response to the heartbeat request; and
sending the response to the target device.

14. The method according to claim 1, further comprising:
receiving, from the target device, a task status calibration request regarding one or more tasks executed by the target device, the task status calibration request indicating an execution status of the one or more tasks after the target device restarts or recovers from an abnormal state; and
calibrating the execution status of the one or more tasks according to the task status calibration request.

15. The method according to claim 1, wherein the heartbeat request includes information of at least one of the following: CPU usage, memory usage, disk usage, and execution status of one or more tasks executed by the target device.

16.-28. (canceled)

29. A task scheduling apparatus, comprising:
a memory storing a set of instructions; and
a processor configured to execute the set of instructions to cause the task scheduling apparatus to:
acquire a target task to be deployed to a target device;
generate a confirmation signal according to the target task, the confirmation signal indicating task content of the target task; and
in response to a heartbeat request being received from the target device, send the confirmation signal to the target device.

30.-33. (canceled)

34. A non-transitory computer readable medium that stores a set of instructions that is executable by at least one processor of a computer to cause the computer to perform a task processing method, the method comprising:
acquiring a target task to be deployed to a target device;
generating a confirmation signal according to the target task, the confirmation signal indicating task content of the target task; and
in response to a heartbeat request being received from the target device, sending the confirmation signal to the target device.

35. The non-transitory computer readable medium according to claim 34, wherein the set of instructions that is executable by the at least one processor of the computer causes the computer to further perform:
generating a dual-state record corresponding to the target task, the dual-state record including an expected state and an actual state of the target task;
receiving a task synchronization request sent by the target device, the task synchronization request indicating an execution status of the target task; and
updating the dual-state record according to the execution status of the target task.

36. (canceled)

37. The non-transitory computer readable medium according to claim 35, wherein whether the target task is abnormal is determined by scanning the dual-state record, and the set of instructions that is executable by the at least one processor of the computer causes the computer to further perform:
determining whether the expected state is the same as the actual state, and in response to the expected state being different from the actual state throughout a preset period of time, triggering an exception handling mechanism; or
determining whether the actual state indicates an abnormal state, and in response to the actual state indicating an abnormal state, triggering the exception handling mechanism.

38. The non-transitory computer readable medium according to claim 34, wherein the acquiring the target task comprises:
receiving a first task sent by a console, the first task including a scheduling policy, a deployment address, and content of the first task, the deployment address pointing to the target device;
parsing the deployment address and determining a state of the target device based on the deployment address; and
in response to the target device being in a normal state, generating the target task according to the scheduling policy and the content of the first task.

39. The non-transitory computer readable medium according to claim 34, wherein before the acquiring the target task, the set of instructions that is executable by the at least one processor of the computer causes the computer to further perform:
receiving device information sent by the target device;
generating, based on the device information, a runtime environment identifier corresponding to the target device; and
sending the runtime environment identifier to the target device.

40. The non-transitory computer readable medium according to claim 39, wherein the generating the confirmation signal according to the target task comprises:
generating the confirmation signal according to the target task and the device information.

41.-47. (canceled)
